(19) United States
(12) Patent Application Publication
(10) Pub. No.: US 2026/0270050 A1
(43) Pub. Date: Sep. 10, 2026

(54) SYSTEM AND METHOD FOR SECURE AGGREGATION FOR PRIVACY-PRESERVING FEDERATED LEARNING

(71) Applicant: UNIVERSITY OF SOUTH FLORIDA, Tampa, FL (US)

(72) Inventors: Rouzbeh BEHNIA, Tampa, FL (US); Mohammadreza EBRAHIMI, Tampa, FL (US); Thang HOANG, Blacksburg, VA (US); Balaji PADMANABHAN, Tampa, FL (US)

(21) Appl. No.: 19/165,934

(22) PCT Filed: Mar. 18, 2024
(86) PCT No.: PCT/US2024/020462

§ 371 Date: Sep. 16, 2025

Related U.S. Application Data
(60) Provisional application No. 63/490,814, filed on Mar. 17, 2023.

(51) Int. Cl. H04L 9/08; G06N 20/00; H04L 9/14

(52) U.S. Cl. CPC H04L 9/085; G06N 20/00; H04L 9/14

(57) ABSTRACT

Described herein are systems and methods for securely aggregating federated learning updates for a machine learning model. The method includes executing a set-up routine and iteratively executing an aggregation routine and sending the updated machine learning model to each user. The system includes a distributed computing network, the distributed computing network including a plurality of users, a plurality of assisting nodes, and a central server, which aggregates users local model updates.

### CROSS-REFERENCE TO RELATED APPLICATION

This application claims priority to, and the benefit of, U.S. Provisional Patent Application No. 63/490,814, filed Mar. 17, 2023, entitled “FESA: Fast and Efficient Secure Aggregation for Privacy-preserving Federated Learning,” which is incorporated by reference herein in its entirety.

### BACKGROUND

Federated learning (FL) is promising in training centralized machine learning (ML) models from the contribution of distributed parties while maintaining the privacy of their local data [22, 23]. The participating parties train a “local model” on their local data instead of directly sharing them with others. At the end of each iteration, the local gradient updates representing the changes needed to improve the global model are then transmitted back to a central server, which is tasked to make use of them to derive and return an updated version of a global ML model to the participants.

Unfortunately, local gradients could leak information about users' data [19]. For instance, in developing next-word prediction models [16], the gradients could leak individual words typed by users. Observing that the FL server does not need to have access to the individual gradients but only needs an element-wise weighted average of the gradient vectors in deriving the updated/final model; a secure aggregation protocol [7, 9, 27] is used to compute the sum of weights (followed by a division of a publicly known number of participants), which keeps individual gradients private. The secure aggregation protocol of Bonawitz et al. [7] let each user. mask their gradients with two random masking terms that are selected symmetrical (among each user pair) and then secret-shared among other users [9, 27]. Their protocol requires multiple rounds of communication. Since then, a large body of privacy-preserving aggregation protocols have been proposed, mainly based on multiparty computation (MPC) (e.g., [3, 14, 17, 18, 21]).

The core practical challenges [7] include achieving efficient processing of high-dimensional gradient vectors; achieving efficient setup for users with weak devices and connections; robustness against users dropping out; and strong security against malicious attacks such as model poisoning in a server-mediated environment.

### SUMMARY

Secure aggregation protocols ensure the privacy of users' data in the federated learning settings by preventing the disclosure of users' local gradients. Despite their merits, existing aggregation protocols often incur high communication and computation overheads on the participants and might not be optimized to handle the large update vectors for machine learning models efficiently. This paper presents e-SeaFL, an efficient, verifiable secure aggregation protocol taking one communication round in aggregation. e-Sea FL allows the aggregation server to generate proof of honest aggregation for the participants. The core idea is to employ a set of assisting nodes to help the aggregation server, under similar trust assumptions existing works placed upon the participating users. For verifiability, e-SeaFL uses authenticated homomorphic vector commitments. Experiments show that the user enjoys five orders of magnitude higher efficiency than the state of the art (PPML 2022) for a gradient vector of a high dimension up to 100,000.

In some aspects, the disclosed method for securely aggregating federated learning updates for a machine learning model includes: executing a set-up routine, wherein the set-up routine includes: generating a plurality key pairs, wherein each user has a unique key pair, and each of a plurality of assisting nodes has a unique key pair; sharing a public key of the unique key pair of each user with each of the plurality of assisting nodes and a central server; generating a plurality of shared secrets shared between each user and each of the plurality of assisting nodes; iteratively executing an aggregation routine: generating, at each user, a masked local update including a related shared secret; generating, at each of the plurality of assisting nodes, an unmasking term related to the shared secret; iteratively updating the machine learning model at the central server by aggregating masked local model updates from each user and unmasking terms; and sending the updated machine learning model to each user.

In some aspects, the method further includes: at each iteration: receiving, at each of the plurality of assisting nodes, a participation message from each user; adding each user that sent a participation message to an assisting node user list; receiving, at the central server, a participation message with the masked local update from each user; adding each user that sent a participation message to a central server user list; comparing the assisting node user list of each assisting node to the central server user list, and wherein in response to the comparison, aborting the iterative update when one or more assisting node user lists is not identical to the central server user list.

In some aspects, the method further includes (i.e. malicious settings): generating a signature key pair for each user and each of the plurality of assisting nodes; receiving, at each of the plurality of assisting node, a public signature key of each user and receiving, at each user, the signature key of each of the plurality of assisting nodes; receiving, at the central server, a public signature key for each user and each of the plurality of assisting nodes; generating, at the central server, a signature key pair; and sending, from the central server, a public signature key to each of the users; verifying the public signature key of each user at the assisting nodes and central server; and wherein when the public signature key of a user is verified, the user is added to the assisting node user list and to the central server user list.

In some aspects the method further includes (i.e., proof of model integrity): generating, at each of the plurality of assisting nodes, an authentication factor; generating as a function of the authentication factor and shared secret at each of the plurality of assisting nodes, an encoding vector; sending, from each of the plurality of assisting nodes, the encoding vector to each user; generating, at each user, the authentication factor as a function of the encoding vector and shared secret; generating, at each user, a commitment vector as a function of the authentication factor; sending, from each user to the central server, the commitment vector together with the masked local update; generating, at the central server, an integrity factor as a function of the commitment vector, and the unmasking terms of each of the plurality of assisting nodes; sending the updated machine learning model and integrity factor from the central server to each user; validating, as a function of the updated machine learning model, the authentication factor, and integrity factor; and wherein when the updated machine learning model is determined to be valid, accepting, at the user, the updated machine learning model.

In some aspects, the set-up routine further includes: sharing a security parameter (κ), a number of assisting nodes, and a key exchange protocol (Σ) are shared parameters between each user, the plurality of assisting nodes, and the central server.

In some aspects, the assisting nodes include a plurality of users or a plurality of servers on a shared network.

In some aspects, the set-up routine is executed offline.

In some aspects, communications are conducted on an authenticated channel.

In some aspects, at least one assisting node is honest (i.e. not corrupt).

In some aspects, the method further includes: comparing a number of users in the assisting node user list to an allowable fraction of total number of users, wherein the allowable fraction is a tolerance factor for user dropout; wherein when fewer users are in the assisting node list than the allowable fraction of total number of user, the unmasking term is not generated and the process aborts.

In some aspects, the described system for securely aggregating federated learning updates for a machine learning model, includes: A distributed computing network, wherein the distributed computing network includes: a plurality of users including at least one processor and data storage; a plurality of assisting nodes including at least one processor and data storage; a central server including at least one processor, wherein the distributed computing network is configured to: execute a set-up routine, wherein the set-up routine includes: generating a plurality key pairs, wherein each user has a unique key pair, and each of a plurality of assisting nodes has a unique key pair; sharing a public key of the unique key pair of each user with each of the plurality of assisting nodes and a central server; generating a plurality of shared secrets, shared between each user and each of the plurality of assisting nodes; iteratively execute an aggregation routine, wherein the aggregation routine includes: generating, at each user, a masked local update including a related shared secret; generating, at each of the plurality of assisting nodes, an unmasking term related to the shared secret; iteratively updating the machine learning model at the central server by aggregating masked local model updates from each user and unmasking terms; and sending the updated machine learning model to each user.

In some aspects, the distributed computing system is further configured to: at each iteration, receive, at each of the plurality of assisting nodes, a participation message from each user; add each user that sent a participation message to an assisting node user list; receive, at the central server, a participation message with the masked local update from each user; add each user that sent a participation message to a central server user list; compare the assisting node user list of each assisting node to the central server user list; and wherein in response to the comparison, abort the iterative update when one or more assisting node user lists is not identical to the central server user list.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is an example system of multiparty computation.

FIGS. 2A and 2B are examples of the method of secure aggregation for privacy-preserving federated learning.

FIGS. 3A and 3B are reproductions of Algorithm 1, of the setup phase (FIG. 3A) and round 1 production (FIG. 3B).

FIGS. 4A and 4B are reproductions of Algorithm 2, of the aggregation phase and round 1 production (FIG. 4A) and round 2 production (FIG. 4B).

FIGS. 5A-5C show computational cost in the setup phase at the server (FIG. 5A), user (FIG. 5B), and assisting node (FIG. 5C).

FIGS. 6A-6C show outbound bandwidth in the setup phase at the server (FIG. 6A), user (FIG. 6B), and assisting node (FIG. 6C).

FIGS. 7A-7C show computational cost in the aggregation phase at the server (FIG. 7A), user (FIG. 7B), and assisting node (FIG. 7C).

FIGS. 8A-8C show outbound bandwidth in the aggregation phase at the server (FIG. 8A), user (FIG. 8B), and assisting node (FIG. 8C).

FIG. 9 is an example of a general computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “about” or “approximately” when referring to a measurable value such as an amount, a percentage, and the like, is meant to encompass variations of ±20%, ±10%, ±5%, or ±1% from the measurable value.

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or targets) during training with both labeled and unlabeled data.

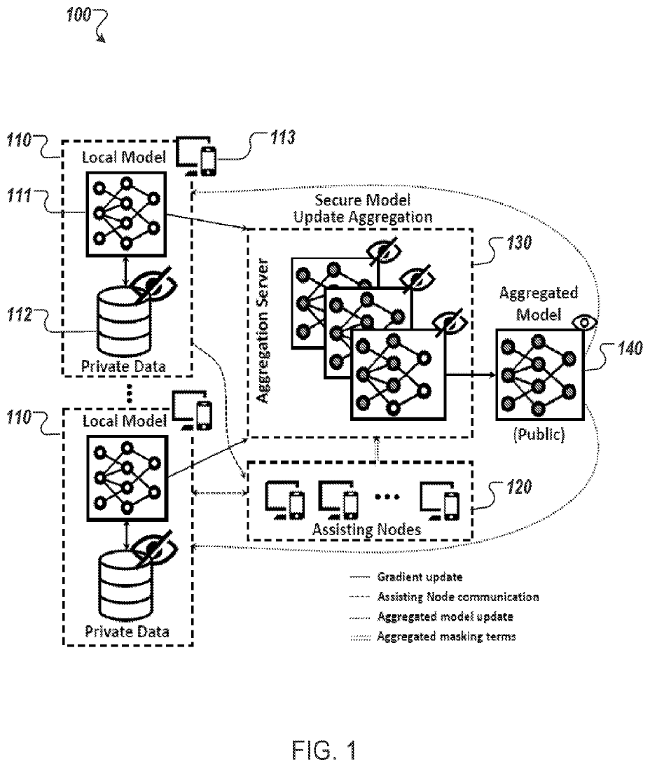

Referring now to FIG. 1, a multiparty system for federated learning of a machine model is presented. The system 100 includes users 110, assisting nodes 120, and an aggregation server 130. The users 110 include a user computing device 113, a local model 111 that is processed and/or stored on the user computing device 113 and private data 112 that is stored on the user computing device 113. The private data 112 is used to train the local model 111 on the user computing device 113. The user 110 is networked to a plurality of assisting nodes 120 and an aggregation server 130. The assisting nodes 120 are the same or separate from the users 110 and provide a separate set of masking vectors that unmask the aggregate of users' local models at the aggregation server 130. This provides enhanced data security for user's private data used to train the local model. The assisting nodes 120 are networked to the aggregation server 130. The aggregation server 130 updates a central machine learning model from trained local models of all users 110, forming an aggregated model 140. The aggregated model 140 is shared with the users 110 as a local model 111.

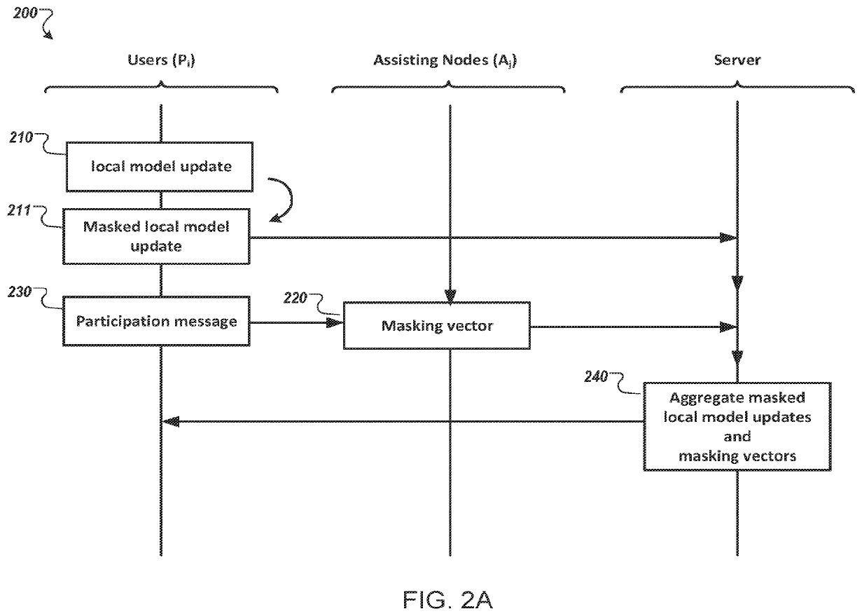

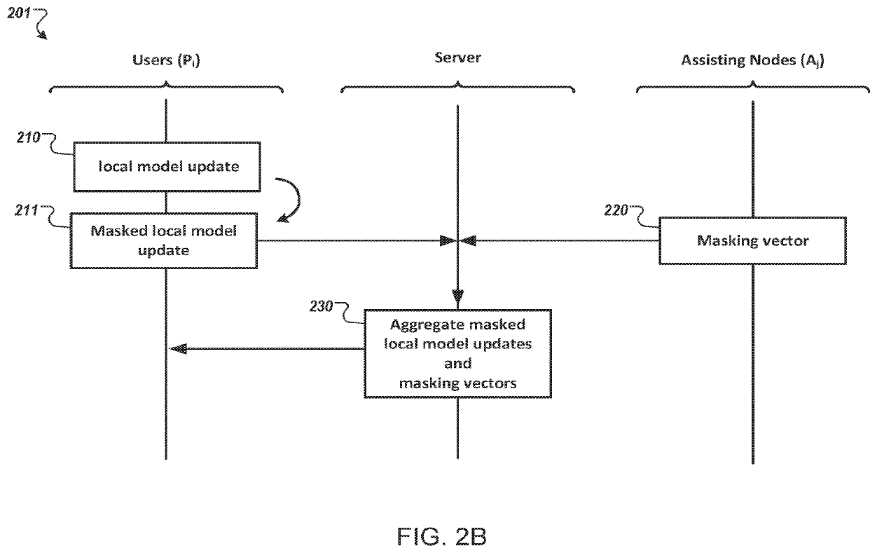

Referring now to FIG. 2A, an example method for secure aggregation in federated learning is shown. The method 200 starts with a user (Pi) computing a local model update 210 then masking the local model update 211. The local masked update 211 is sent from the user (Pi) to a server. Separately, the user (Pi) sends a participation message 230 to the assisting node (Aj), then the assisting node (Aj) computes related masking vector 220 based on a shared secret. After all local model updates 211 and masking vectors 220 are received, the server aggregates the masked local model update and masking vector 240.

Referring now to FIG. 2B, an example method of secure aggregation in federated learning is shown. The method 201 starts with a user computing a local model update 210 then masking the local model update 211. The local masked update 211 is sent from the user to a server. An assisting node computes related masking vectors 220 for each masked local model update. After all local model updates 211 and masking vectors 220 are received, the server aggregates the masked local model update and masking vector 230.

In some embodiments, a method for securely aggregating federated learning updates for a machine learning model are described. The method includes executing a set-up routine and iteratively executing an aggregation routine, for example, the routine shown in FIGS. 2A and 2B, and sending the updated machine learning model to each user.

The set-up routine includes generating a plurality of key pairs, wherein each user has a unique key pair and each of a plurality of assisting nodes has a unique key pair; sharing a public key of the unique key pair of each user with each of the plurality of assisting nodes and a central server; and generating a plurality of shared secrets, shared between each user and each of the plurality of assisting nodes.

The set-up routine further includes sharing a security parameter, a number of assisting nodes, and a key exchange protocol parameters between each user, the plurality of assisting nodes, and the central server.

In some implementations, a user executes the set-up routine when offline.

The aggregation routine includes at each iteration, generating, by each user, a masked local update including a related shared secret; generating, at each of the plurality of assisting nodes, an unmasking term related to the shared secret; iteratively updating the machine learning model at the central server by aggregating masked local model updates from each user and unmasking terms.

In some embodiments, the method includes, at each iteration, receiving, at each of the plurality of assisting nodes, a participation message from each user; adding each user that sent a participation message to an assisting node user list; receiving, at the central server, a participation message with the masked local update from each user; adding each user that sent a participation message to a central server user list; and comparing the assisting node user list of each assisting node to the central server user list. In response to the comparison, aborting the iterative update when one or more assisting node user lists is not identical to the central server user list.

In some embodiments, a malicious protocol is employed. The malicious protocol is used in situations when the corrupted parties actively deviate from the protocol in order to undermine security. The method further includes generating a signature key pair for each user and each of the plurality of assisting nodes; receiving, at each of the plurality of assisting node, the public signature key of each user and receiving, at each user, the signature key of each of the plurality of assisting nodes; receiving, at the central server, a public signature key for each user and each of the plurality of assisting nodes; generating, at the central server, a signature key pair; and sending, from the central server, a public signature key to each of the users; verifying the public signature key of each user at the assisting nodes and central server; and wherein when the public signature key of a user is verified, the user is added to the assisting node user list and to the central server user list.

In some embodiments, a routine for proof of model integrity is employed such that a user, after sending a local model update to the central server, checks model integrity of the updated machine learning model before accepting the update. The proof of integrity routine includes generating, at each of the plurality of assisting nodes, an authentication factor; generating as a function of the authentication factor and shared secret, at each of the plurality of assisting nodes, an encoding vector; sending, from each of the plurality of assisting nodes, the encoding vector to each user; generating, at each user, the authentication factor as a function of the encoding vector and shared secret; generating, at each user, a commitment vector as a function of the authentication factor; sending, from each user to the central server, the commitment vector together with the masked local update; generating, at the central server, an integrity factor as a function of the commitment vector, and the unmasking terms of each of the plurality of assisting nodes; sending the updated machine learning model and integrity factor from the central server to each user; validating, as a function of the updated machine learning model, the authentication factor, and integrity factor, wherein when the updated machine learning model is determined to be valid, the updated machine learning model is accepted by the user.

In some implementations, the method further includes comparing a number of users in the assisting node user list to an allowable fraction of total number of users, wherein the allowable fraction is a tolerance factor for user dropout; wherein when fewer users are in the assisting node list than the allowable fraction of total number of user, the unmasking term is not generated and the process aborts. In some aspects, at least one assisting node is honest (i.e. not corrupt).

In some implementations, communications are conducted on an authenticated channel. In other implementations, the assisting nodes comprise a plurality of users or a plurality of servers on a shared network.

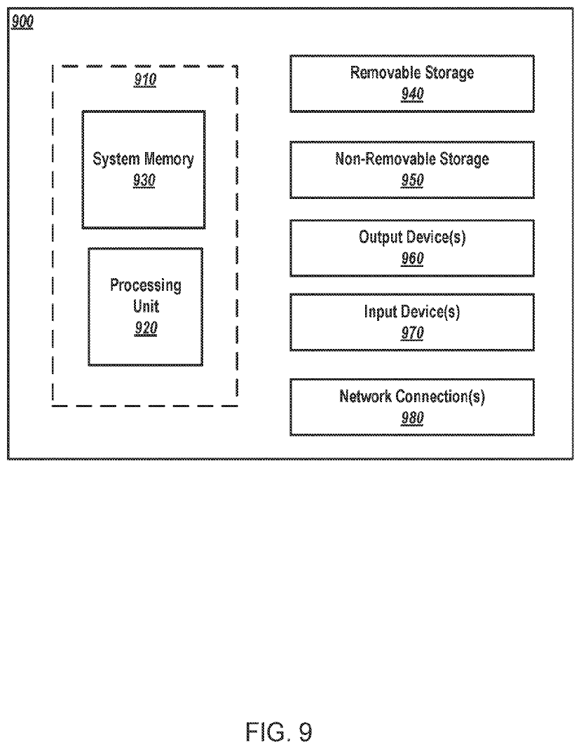

It should be appreciated that the logical operations described herein with respect to the various figures may be implemented (1) as a sequence of computer implemented acts or program modules (i.e., software) running on a computing device (e.g., the computing device described in FIG. 9), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 9, an example computing device 900 upon which the methods described herein may be implemented is illustrated. It should be understood that the example computing device 900 is only one example of a suitable computing environment upon which the methods described herein may be implemented. Optionally, the computing device 900 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 900 typically includes at least one processing unit 920 and system memory 930. Depending on the exact configuration and type of computing device, system memory 930 may be volatile (such as random access memory (RAM), non-volatile (such as read-only memory (ROM), flash memory, etc.), or some combination of the two. This most basic configuration is illustrated in FIG. 9 by box 910. The processing unit 930 may be a standard programmable processor that performs arithmetic and logic operations necessary for operation of the computing device 900. The computing device 900 may also include a bus or other communication mechanism for communicating information among various components of the computing device 900.

Computing device 900 may have additional features/functionality. For example, computing device 900 may include additional storage such as removable storage 940 and non-removable storage 9500 including, but not limited to, magnetic or optical disks or tapes. Computing device 900 may also contain network connection(s) 980 that allow the device to communicate with other devices. Computing device 900 may also have input device(s) 970 such as a keyboard, mouse, touch screen, etc. Output device(s) 960 such as a display, speakers, printer, etc. may also be included. The additional devices may be connected to the bus in order to facilitate communication of data among the components of the computing device 900. All these devices are well known in the art and need not be discussed at length here.

The processing unit 920 may be configured to execute program code encoded in tangible, computer-readable media. Tangible, computer-readable media refers to any media that is capable of providing data that causes the computing device 900 (i.e., a machine) to operate in a particular fashion. Various computer-readable media may be utilized to provide instructions to the processing unit 920 for execution. Example tangible, computer-readable media may include, but is not limited to, volatile media, non-volatile media, removable media and non-removable media implemented in any method or technology for storage of information such as computer readable instructions, data structures, program modules or other data. System memory 930, removable storage 940, and non-removable storage 950 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 920 may execute program code stored in the system memory 930. For example, the bus may carry data to the system memory 930, from which the processing unit 920 receives and executes instructions. The data received by the system memory 930 may optionally be stored on the removable storage 940 or the non-removable storage 950 before or after execution by the processing unit 920.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

In some implementations, a computing device comprises graphical compute units (GPUs). A GPU is a processing chip comprised of a grid of compute cores. Compared to a conventional computer processing unit (CPU), GPUs increase the number of compute cores by decreasing the footprint (and size) of CACHE memory. The architecture of GPUs are configured to increase processing power and decrease the amount of and duration of data storage, which makes the GPU preferable for streamed data applications, such as rendering high frames-per-second video. A computing device may have both CPUs and GPUs or variations thereof.

### EXAMPLES

The following examples are put forth so as to provide those of ordinary skill in the art with a complete disclosure and description of how the compounds, compositions, articles, devices and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

The following techniques and methods are used to hide a secret update, wᵢ. MPC-based approaches (e.g., [3, 7, 18]) require each user Pᵢ to derive a mask term hᵢ, which can be canceled out when the masked updates are aggregated as in Σ_{i∈[n]}hᵢ=0. Each pair of users Pᵢ and Pⱼ use (non-interactive) key agreement to derive a key mk_{i,j}, which can be used to derive the mask for each iteration, to be canceled when both Pi and Pj participated. For robustness against dropout users, mk_{i,j} is secret-shared by t-out-of-n Shamir secret sharing [29]. For security against a malicious server, the protocol often involves more than one masking term.

Assisting nodes based on similar trust assumptions. Most existing works (e.g., [3, 7, 18]) assume a subset of users must remain honest. On one hand, more data contribution from more users is better for training. On the other hand, the number of dishonest/compromised users might eventually outnumber honest users. This assumption is relaxed and extended to a set of assisting nodes, which shares a secret seed with the users and assist the server in unmasking the final gradient by providing partial aggregated masking terms of the participating users derived from the seeds. It is assumed that even if all but one of the assisting nodes corrupt, the user gradients will not be leaked. This allows a simpler design for efficiency improvement during both setup and aggregation. It is noted that the use of similar assisting entities has been in many other domains (e.g., [2, 11, 20, 30]). Moreover, a rotating set of users can serve as assisting nodes in each training phase, especially when the overhead imposed on the assisting nodes is even lower than that of users in efficient protocols such as MicroFedML [18].

Poising detection via proof of honest aggregation. The malicious security model of existing work [3, 7, 18]) only considers privacy attacks and does not capture the integrity of the final model computed by the aggregation server. An attempt to achieve the proof of integrity [17]) was shown to be insecure, and the potential fix (if secure) could affect the computation overhead of the protocol. e-SeaFL utilizes authenticated homomorphic vector commitments to provide proof of honest aggregation to the participating parties. Namely, each user first commits to their gradient. The homomorphism and unforgeability enable individual users to check the integrity of the final aggregated model.

### Preliminaries

Notations. Vectors are noted by bold lowercase letters (e.g., a).

$$a {←}^{\$} ℤ$$

denotes α is randomly sampled from [symbol] . A hash function H(⋅) is used to map the input to the masking term vector space. Let g=(g₁, . . . , g_{d}) and x=(x₁, . . . , xₙ) and denote

$${g}^{x} = {\prod }_{i = 1}^{d} {g}_{i}^{{x}_{i}} .$$

Cryptographic Building Blocks. A key exchange protocol allows two parties to agree on a symmetric key securely over a public channel.

Definition 1 (Key Exchange). A key exchange protocol is a tuple of algorithms Σ: (KeyGen,Agree) defined as follows.

(pk_{Σ}, sk_{Σ})←KeyGen(l^{κ}): takes as input a security parameter κ and outputs a key pair (pk_{Σ}, sk_{Σ}).

$${x}_{U 1}^{U 2} ← Agree ( {pk}_{\sum }^{U 1} , {sk}_{\sum }^{U 1} ) :$$

Takes as input the public key of any user

$${pk}_{\sum }^{U 1}$$

and the private key of user U₂,

$${sk}_{\sum }^{U 2} ,$$

and outputs a shared secret key

$${x}_{U 1}^{U 2} .$$

For semi-honest security any probabilistic polynomial time (PPT) adversary who is given two honestly generated public keys

$${pk}_{\sum }^{P 1} and {pk}_{\sum }^{P 2} ,$$

but without either of the corresponding secret keys

$$( {sk}_{\sum }^{P 1} or {sk}_{\sum }^{P 2} ) ,$$

is unable to distinguish the shared secret

$${x}_{P 1}^{P 2}$$

from a uniformly random value. A malicious adversary has additional access to an oracle OAgree(⋅) and is able to learn the output for any pair of keys except for P₁ and P₂. Protocols used in existing works [3, 7] based on the corresponding Diffie-Hellman assumptions are used herein.

Definition 2 (Digital Signatures). A digital signature scheme Π for a messages space [symbol] is defined by KeyGen, Sign, and Verify):
(pk, sk)←KeyGen(l^{κ}): Takes as input a security parameter κ and outputs a key pair (pk_{Π}, sk_{Π}).
σ←Sign(sk_{Π}, m): Takes as input sk_{Π} and a message m∈M_{Π}, and outputs a signature σ.
{0, 1}←Verify(pk_{Π}, m, σ): Takes as input pk_{Π}, a message m∈ [symbol] _{Π}, a signature σ and outputs 1 if σ is a valid signature under pk_{Π} for message m. Otherwise, it outputs 0.

Correctness requires that for any m∈ [symbol] _{Π}, Verify(pk_{Π}, m, σ)=1, where (pk_{Π}, sk_{Π})←KeyGen(l^{κ}) and σ←Sign(sk_{Π}, m).

Existential unforgeability against adaptive chosen message attacks is the de facto standard. It requires that any PPT adversary which has provided a public key and access to a signing oracle cannot create a forgery on a message not queried to the oracle.

Definition 3 (Authenticated encryption [4]). Given a shared secret key x∈ [symbol] _{AE} in a key space [symbol] _{AE}, an authenticated encryption AE: (enc, dec) is defined as follows.
c←enc(x,m): Takes as input a shared secret key x and a message m∈ [symbol] _{AE} (for a message space [symbol] _{AE}) and outputs a ciphertext c.
{m,⊥}←dec(x, c): Takes as input a shared secret key x and a ciphertext c and outputs either the original message m or an error ⊥.

Indistinguishability against chosen-plaintext attack (JND-CPA property) requires that any PPT adversary has only negligible advantage in distinguishing between ciphertexts of two different adversary-chosen messages.

Ciphertext integrity (INT-CTXT) requires that no PPT adversary can forge valid ciphertexts of messages not queried to the encryption oracle.

Definition 4 (Vector Commitment). A vector commitment VC: (Setup, Comm) for a vector space [symbol] _{VC}^{d}, randomness space [symbol] _{VC}, and commitment space [symbol] _{VC} consists of the following PPT algorithms
pp←Setup(l^{κ}, d): Takes as input security parameter κ and vector length d, and outputs public parameter pp.
cm←Comm(x, r): Takes as input a vector x and a randomness r, and outputs a committed value cm.

VC offers homomorphic property under ( [symbol] ^{d}, *), ( [symbol] , *), ( [symbol] , ⋅) that ∀x₁, x₂∈ [symbol] ^{d} r₁, r₂∈ [symbol] , VC.Comm(x₁, r₁)·VC.Comm(x₂, r₂)=VC.Comm(x₁*x₂, r₁*r₂).

### For Security:

Binding: For all PPT adversaries Adv, pp←VC.Setup(l^{κ}), (x₀, x₁)←Adv(pp),

$$b {←}^{\$} \{ 0 , 1 \} , r {←}^{\$} ℛ , cm = VC \cdot Comm ( {x}_{b} , r ) ,$$

and b←Adv(pp, cm), there exists a negligible function negl such that

$$\vert Pr [ b = {b}^{′} ] - \frac{1}{2} \vert \leq neg 1 ( κ )$$

Hiding: For all PPT Adv, pp←VC.Setup(l^{κ}, d), and (x₀, x₁, r₀, r₁)←Adv(pp) such that x₀, x₁∈ [symbol] ⁿ, there exists a negligible function negl such that Pr[VC.Comm(x₀, r₀)=VC.Comm(x₁, r₁)]≤negl(x).

To provide proof of the model integrity (see FIG. 1 and FIG. 2), an authenticated Pederson vector commitment APVC [24] was used. APVC permits the commitor to commit to a vector in a way that allows the commitor to verify the authenticity of the committed value. APVC has an extra algorithm ρ←KeyGen(l^{κ}) that takes as input a security parameter κ, and outputs a secret ρ as follows.

Definition 5 (Authenticated Pedersen Vector Commitment). Given [symbol] , [symbol] = [symbol] ₚ, [symbol] = [symbol] of order p, an authenticated Pedersen vector commitment APVC: (Setup, KeyGen, Comm) is defined as follows.
(g, h)←Setup(l^{κ},d): Takes as input a security parameter κ and an integer d it outputs a vector g=(g₁, . . . , g_{d}) and

$$h {←}^{\$} 𝔾 .$$

ρ←KeyGen(l^{κ}): Takes as input a security parameter κ and outputs

$$ρ {←}^{\$} {ℤ}_{p} .$$

cm←Comm(ρ, x, r): Takes as input an input vector x=(x₁, . . . , x_{d}), ρ and r and outputs the commitment

$$cm ← {h}^{r} {g}^{ρ x} = {h}^{r} {\prod }_{i = 1}^{n} {g}_{i}^{ρ {x}_{i}} ∈ 𝔾 .$$

APVC is homomorphic under

$$( {ℤ}_{p}^{n} , + ) ,$$

( [symbol] ₚ, +), and ( [symbol] , ⋅). Specifically, Comm(ρ, x₁, r₁)·Comm(ρ, x₂, r₂)=Comm(ρ, x₁+x₂, r₁+r₂).

Definition 6 (Unforgeability modulo homomorphism). Unforgeability of APVC is defined via a game EUGame_{Adv}(κ) between challenger C and adversary Adv: Setup. The challenger C samples a random secret

$$ρ {←}^{\$} 𝒦 ,$$

and initializes an empty list [symbol] which records the responds to Adv's queries in form of tuples (x, r) and can be queried s.t. x← [symbol] (r).

Query. Adv adaptively submits a query to C as (x, r), where x is a vector to be committed, and r is randomly sampled. C rejects if r∈ [symbol] . Otherwise, C computes cm←APVC. Comm(ρ, x, r) and sends cm to Adv.C adds (r; x) to [symbol] .

Output. Adv outputs a vector x*, a commitment cm*, m randoms

$$( {r}_{1}^{*} , … , {r}_{m}^{*} ) ,$$

and m constants

$$( {c}_{1}^{*} , … , {c}_{m}^{*} )$$

such that

$${\sum }_{i = 1}^{m} {c}_{i}^{*} {r}_{i}^{*} ∉ ℒ ,$$

Adv wins and the game outputs 1 if (i)

$$cm *= APVC \cdot Comm ( ρ , x * , {\sum }_{i = 1}^{m} {c}_{i}^{*} {r}_{i}^{*} ) , \qquad ( ii )$$

$$( {c}_{1}^{*} , … , {c}_{m}^{*} )$$

are not all zeros (trivial forgery), and (iii) Unforgeability is with respect to homomorphism: Either 1)

$$∃ {r}_{i}^{*} ∉ ℒ$$

for some

$$i ∈ [ m ] , or 2 ) {r}_{i}^{*} ∉ ℒ ,$$

$$∀ i ∈ [ m ] and {x}^{*} \neq {\prod }_{i = 1}^{m} ( {c}_{i} \cdot {x}_{i} ) , where {x}_{i} ← ℒ ( {r}_{i}^{*} ) .$$

APVC achieves unforgeability if Pr[EUGame_{Adv}(κ)]≤negl(κ).

### System Model.

Definition 7 (Aggregation Protocol [3, 7]). An aggregation protocol F: ( [symbol] , S, T) with a set of users [symbol] , an aggregation server S, set of assisting nodes [symbol] , and integer set T, takes places in two phases:

First, the setup phase, which runs only once to set up the entities with their keys and complete key distribution.

Second, the aggregation phase, which runs for T iterations. Each iteration t∈T of starts by each party Pᵢ computing a local update

$${w}_{t}^{{P}_{i}}$$

and ends by the server outputting the update

$${w}_{t} = {\sum }_{\dot{P} i ∈ 𝒫} {w}_{t}^{{P}_{i}}$$

based on the input provided by each participating party.

Correctness with dropout rate δ is said to hold if in each iteration t∈T, for all the sets of offline users [symbol] ₀⊂ [symbol] where | [symbol] ₀|<δ| [symbol] |, the server outputs

$${w}_{t} = {\sum }_{Pi ∈ 𝒫 / {𝒫}_{0}} {w}_{t}^{{P}_{i}}$$

with an overwhelming probability.

As FIG. 1 illustrates, the system consists of:

1) n parties (or interchangeably “users”) {P₁, . . . , Pₙ} who aim to contribute to collaborative training a shared model by computing local gradient vectors

$${w}_{t}^{{P}_{i}}$$

on their (private) data at each iteration t.

2) A set of k assisting nodes {A₁, . . . , Aₖ} which securely assist the aggregation server in aggregating the local updates. It was noted that given the low computation and communication overhead of the assisting node, it is contemplated that a set of rotating users can assume the role of assisting nodes in each iteration.

3) A central aggregation server S, which is in charge of aggregating the local user's updates

$${w}_{t}^{{P}_{i}}$$

and sending the updated model wₜ back to the users after each completed iteration.

A number of assisting nodes, k, are introduced to the system to increase security of user data during transmission, unlike previous models (e.g., [3, 7, 18]). The assisting nodes only communicate with the user in the initialization phase, and the users only send a (authenticated) participation message to the assisting nodes in each iteration.

A description of the workflow and discussion of the additional steps needed in each phase to provide proof of model aggregation integrity is as follows:

(1) Setup phase: The Setup phase is a one-time process that may be carried out (at least in-part) offline. This phase takes place in one round only, namely, KeyGen and Advertise. At the end of this phase, all the parties {P₁, . . . , Pₙ} and assisting nodes {A₁, . . . , Aₖ} are initialized with the key exchange scheme (plus a digital signature scheme in the malicious setting) public keys. The assisting nodes and the aggregation server receive a copy of the user public keys. Additionally, all parties {P₁, . . . , Pₙ} and assisting nodes {A₁, . . . , Aₖ} have a computed a shared secret x.

(2) Aggregation phase: This phase consists of two rounds: Masking Updates and Aggregate Updates. As in FIG. 1:

Step 1: Each party Pᵢ, after computing the local update

$${w}_{t}^{{P}_{i}}$$

compute the masked update

$${y}_{t}^{{P}_{i}} .$$

Step 2: Pᵢ sends the masked update

$${y}_{t}^{{P}_{i}}$$

and a participation message to the aggregation server S and the k assisting nodes, respectively.

Step 3: After receiving the participation message from the participants, each assisting node computes an aggregated masking vector

$${a}_{t}^{{A}_{j}} .$$

Step 4: All the assisting nodes {A₁, . . . , Aₖ} send their aggregated masks

$${a}_{t}^{{A}_{j}}$$

for j ∈{1, . . . , j} to S. For malicious security, the outgoing messages are signed by the assisting nodes.

Step 5: S aggregates the final model using the user's local masked updates

$${y}_{t}^{{P}_{i}}$$

and the aggregated masks

$${a}_{t}^{{A}_{j}}$$

provided by the assisting nodes.

Step 6: The aggregation server sends the updated model wₜ to the parties.

Additionally presented is an extension to the e-SeaFL protocol to protect the model's integrity against model poisoning attacks. This is done by enabling the aggregation server S to provide proof of honest aggregation. To achieve this, additional steps are to be taken in both the Setup and the Aggregation phases. In the KeyGen and Advertise round (in the Setup phase), one assisting node needs to compute a system-wide authenticated secret and disseminates it to all the parties in the system. Additionally, in the Aggregation phase, after computing the local update, each user needs to send an authenticated commitment to the aggregation server. Lastly, in the last step of the Aggregate updates round, S disseminates to all the users the proof of honest aggregation to check if the final model was indeed formed by honestly aggregating the local updates. To avoid a single point of failure, one can initiate the protocol by having all the assisting nodes generate different system-wide authenticated secrets with a small communication and computation overhead.

Threat Model. The adversary's goal is to learn any information about the individual updates

$${w}_{t}^{{P}_{i}} .$$

The adversary is assumed to be able to control the aggregation server and a bounded fraction of the users and assisting nodes. To capture the unstable network bandwidth in the FL settings, the adversary is allowed to drop or disconnect a fraction of users 6. To preserve the privacy of the user updates, one of the assisting nodes is required to be honest.

In the semi-honest setting, following the literature on multi-party computation [12], the adversary corrupts parties but follows the protocol. The corrupt parties run the protocol honestly but attempt to infer secret information by observing the communication/message they receive from other parties. This scenario can be perceived as a group of passive but colluding parties pooling their views to learn about the secret information.

In the malicious setting, the corrupted parties actively deviate from the protocol in order to undermine security [12]. A malicious adversary has all the capabilities of a semi-honest adversary in analyzing the protocol communication, but it can also take any action such as dropping out, ignoring certain communication, or sending incorrect messages during the protocol execution [12].

In this example, it was contemplated that a malicious aggregation server can poison the model by not honestly aggregating the local updates [5, 8, 13]. An extension was proposed that ensures the integrity of the final model and allows participants to verify (in each iteration) that the aggregation server did honestly aggregate the local user updates.

Following the work in [3], a summation protocol was defined as being α-secure if the honest parties was guaranteed that their re it was aggregated at most once with the minimum of α| [symbol] _{H}| other secrets, where [symbol] _{H} is the set of honest parties. Similar to [3], this summation protocol was used in the simulation-based proof.

Definition 8. [α-summation idealfunctionality] For integers p, n, d and α∈[0, 1], let L⊆[n] and [symbol] _{L}: {xᵢ}i∈L where

$${x}_{i} ∈ {ℤ}_{p}^{d} .$$

For Q_{L} as the set of partitions of L and a collection of pairwise disjoint subsets {L₁, . . . , L₁}∈Q_{L}, the α-summation ideal functionality for all subsets in Q_{L} is denoted as [symbol] _{x,a}(⋅) and computes [symbol] _{x,a}({Lᵢ}_{i∈[1, . . . , l]})→{Sᵢ}_{i∈[1, . . . , l]} where

$$∀ j ∈ [ 1 , … , l ] , {s}_{j} = \{ \begin{matrix}{\sum }_{j ∈ {Q}_{L}} & {x}_{j} \\ ⊥ & otherwise\end{matrix} .$$

The above definition was used to define the privacy of the protocol later by characterizing what an adversary, with control over the aggregation server, cloud learn from the protocol.

Following [7, 18], the notion of privacy was defined against semi-honest/malicious adversaries in the following.

Definition 9. [Privacy of secure aggregation protocols] Given a secure signature scheme Π and a key exchange protocol Y instantiated with security parameter κ, an aggregation protocol Γ: ( [symbol] ,S, T), as defined in Definition 7, provides privacy against a semi-honest (malicious) adversary Ad v, if there is exist a PPT simulator Sim that for any iteration t∈{1, . . . , T}, and all input vectors [symbol] ^{t}={x₁, . . . , xₙ}, generates an output that is computationally indistinguishable from the view of Adv. It is assumed the adversary Adv controls S, a λP fraction of users and a λ_{A} fraction of assisting nodes and its view consists of the joint view of the corrupted server S*, the set of corrupted users [symbol] _{C} and corrupted assisting nodes [symbol] _{C}:

$${REAL}_{S * , {𝒫}_{C} , {𝒫}_{C} , t}^{Γ ( 𝒫 , 𝒜 , S , T )} ( Adv , {\{ {x}_{i} \}}_{i ∈ 𝒫 \backslash {C}_{P} {\approx }_{κ}} {Simul}^{Γ ( 𝒫 , 𝒜 , S , T ) , {{ℱ}_{𝒳 t , α} ( \cdot )}_{{\{ {x}_{i} \}}_{i ∈ 𝒫 \backslash {𝒫}_{C}}}} ( Adv )$$

It is contemplated that an adversary that targets the integrity of the final model by compromising the aggregation server to replace or insert arbitrary gradients to poison the final model [5, 8, 13]. Malicious users could also attempt model poisoning by submitting malicious gradient updates. However, there exist a number of mitigations (e.g., [28]).

### Secure Aggregation Protocol

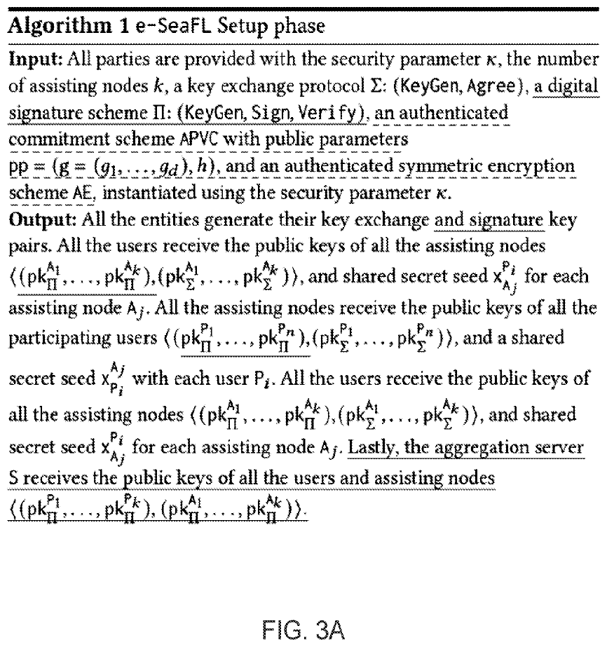

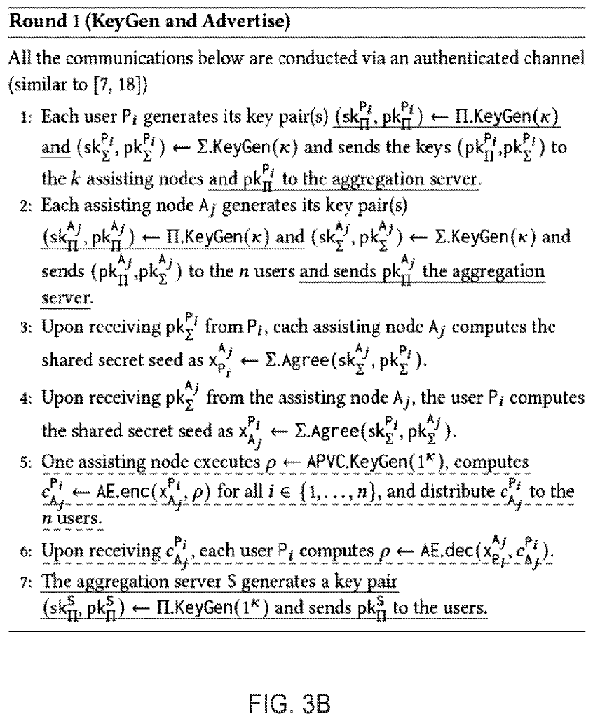

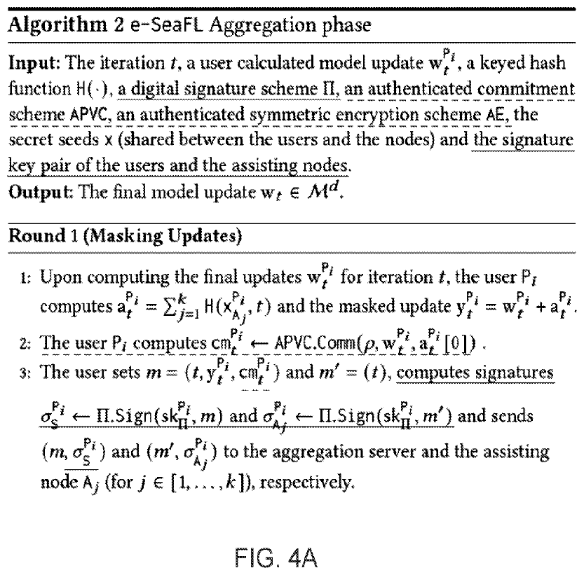

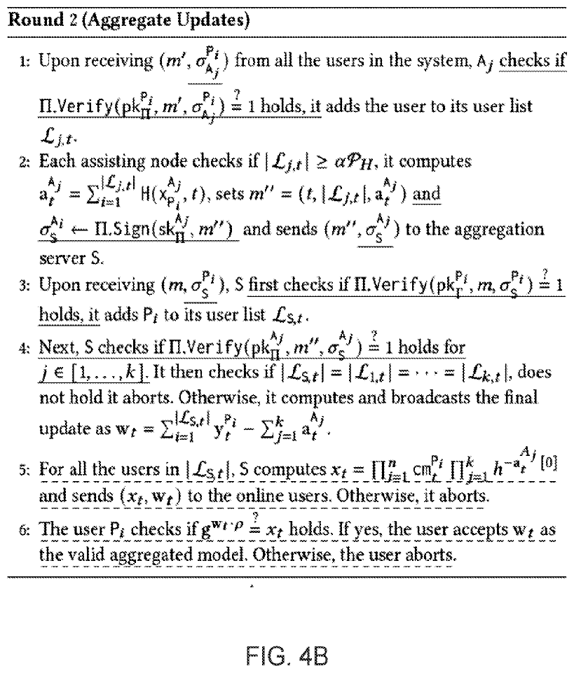

The concrete constructions of e-SeaFL are presented in FIGS. 3A and 3B (i.e. Algorithm 1) and FIGS. 4A and 4B (i.e. Algorithm 2). The local updates

$${w}_{t}^{{P}_{i}} ,$$

are given as high-dimensional vectors instead of individual coordinates as in many of the existing works.

The red and underlined parts are required to provide security in the malicious setting and are not needed in the semi-honest setting. The blue and dashed-underlined parts are required to provide proof of model integrity and are not required for the semi-honest or malicious settings. e-SeaFL relies on authenticated commitment (Definition 5) and authenticated symmetric encryption (Definition 3) for integrity.

Detailed Construction. A set of assisting nodes are introduced to assist the aggregation server in securely aggregating the local gradients and computing the final model. The approach is to extend the assumption made in most of the existing protocols, which rely on a subset of honest users, to a set of assisting nodes. Therefore, for the privacy guarantee of the protocol to hold, only one of the assisting nodes are required to be honest. The computation and communication overhead of the assisting nodes is on par, if not lower, than the users in some of the most efficient counterparts. Thus, a rotating set of users (similar to [11]) assumes the role of the assisting nodes in each iteration.

In the KeyGen and Advertise round in FIG. 3B (i.e. Algorithm 1), for the semi-honest setting, each user generates a key pair

$$( {pk}_{\sum }^{Pi} , {sk}_{\sum }^{Pi} )$$

for the key exchange protocol to computes a shared secret

$${x}_{Pi}^{Aj}$$

with assisting nodes Aⱼ. For the malicious setting, users and assisting nodes are also initialized with signature key pairs. This will be used to sign outgoing communications in the Aggregation phase (Algorithm 2). For the proof of the model's integrity, the underlying APVC algorithm is initialized, and the system secret ρ is computed, encrypted (with each users' shared secret) and sent to all the users.

The first round of the Aggregation phase (FIG. 4A, i.e., Algorithm 2) starts by the user computing a masking vector

$${a}_{t}^{Pi}$$

(using the shared secrets

$${x}_{Pi}^{Aj}$$

for j=1, . . . , k}) to mask its local gradient vector

$${w}_{t}^{Pi} .$$

To achieve the model's integrity, each user computes a commitment cm^{Pi} on their local gradient using APVC. Comm(⋅) and sends it to the aggregation server. Next, the masked gradient

$${y}_{t}^{Pi}$$

and a participation message (e.g., the iteration number) are sent to the aggregation server and the k assisting nodes, respectively. In the malicious setting, the outgoing messages are signed using Π.Sign(⋅).

In the second round of the Aggregation phase (FIG. 4B, i.e., Algorithm 2), for the semi-honest (malicious) setting, upon receiving (and verifying) the participating message (and signature), each Aⱼ adds the user to the list [symbol] _{j,t}. Then for all users in [symbol] jᵢₜ, it computes the aggregation of all their masking terms

$${a}_{t}^{Aj}$$

(using the shared keys

$${x}_{Pi}^{Aj} )$$

and sends

$${a}_{t}^{Aj}$$

to the aggregation server. In the malicious setting, the assisting nodes sign all their outgoing messages using Π.Sign(⋅). Next, for the semi-honest (malicious) setting, upon receiving (and verifying) the participating message (and signature), S adds the user to the list [symbol] _{S,t}. Then it checks if all the user lists (assisting node's and the aggregation server's) are equal. Then, for all the users in [symbol] _{S,t}, the server uses the masked updates (i.e.,

$${y}_{t}^{Pi}$$

and the aggregated masking terms

$${a}_{t}^{Aj} ,$$

supplied by the assisting nodes, to efficiently compute the final model. To provide the proof of the model's integrity, S computes x using the users' commitments

$$c {m}_{t}^{Pi} .$$

Lastly, S sends the final model (and x for the proof of integrity) back to the participating users.

Security Analysis. The correctness of the protocol is resistant to user dropouts as shown below:

Theorem 1. Given a secure and correct key exchange protocol 1, e-SeaFL protocol presented in Algorithms 1 and 2 (i.e., FIGS. 3A-3B and FIGS. 4A-4B, with parameters (1−δ)≥α guarantees correctness with δ offline rate.

Proof. Correctness directly follows from that of the underlying key exchange protocol. Each user's update (e.g.,

$${w}_{t}^{Pi} )$$

is masked by the sum of k masking terms computes as

$${a}_{t}^{Pi} = {\sum }_{j = 1}^{k} PRF ( {x}_{Aj}^{Pi} , t ) ,$$

where the secure pseudorandom function PRF(⋅) is invoked on the input of the iteration number t∈T and a shared secret key

$${x}_{Pi}^{Aj}$$

between Pᵢ and the k assisting nodes Aⱼ for j∈{1, . . . , k}. The shared secret key

$${x}_{Pi}^{Aj}$$

is derived in the Setup phase (FIG. 3A, i.e., Algorithm 1), by invoking the Σ.Agree(⋅) algorithm of the underlying key exchange protocol. Following Algorithm 1, Pᵢ computes

$${x}_{Pi}^{Aj} ← \sum \cdot Agree ( {sk}_{\sum }^{Aj} , {pk}_{\sum }^{Pi} ) ,$$

and Aⱼ computes

$${x}_{Aj}^{Pi} ← \sum \cdot Agree ( {sk}_{\sum }^{Aj} , {pk}_{\sum }^{Pi} ) ,$$

and the correctness of the underlying key exchange protocol ensures that

$${x}_{Pi}^{Aj} = {x}_{Aj}^{Pi} .$$

For the online user list [symbol] _{Aj,t}, each assisting node computes

$${a}_{t}^{Aj} = {\sum }_{i = 1}^{\vert {ℒ}_{j , t} \vert} PRF ( {x}_{Pi}^{Aj} , t ) .$$

Now, given

$${x}_{Pi}^{Aj} = {x}_{Aj}^{Pi}$$

for all Pᵢ and Aⱼ, it is easy to see

$${\sum }_{i = 1}^{k} {a}_{t}^{Aj} = {\sum }_{i = 1}^{{ℒ}_{S , t}} {a}_{t}^{Pi} and {\sum }_{i = 1}^{\vert {ℒ}_{S , t} \vert} {y}_{t}^{Pi} - {\sum }_{i = 1}^{k} {a}_{t}^{Aj} = {\sum }_{i = 1}^{\vert {ℒ}_{S , t} \vert} {w}_{t}^{Pi} + {\sum }_{i = 1}^{\vert {ℒ}_{S , t} \vert} {a}_{t}^{Pi} - {\sum }_{i = 1}^{k} {a}_{t}^{Aj} = {\sum }_{i = 1}^{\vert {ℒ}_{S , t} \vert} {w}_{t}^{Pi} .$$

This is satisfied when the number of participating honest parties (1−δ)| [symbol] ₕ|≥a| [symbol] ₕ|, where α is defined in Definition 8.

For user dropouts, unlike its predecessors (e.g., [3, 7, 18]), e-SeaFL's aggregation phase is one-round. Users only send a single message flow and can go offline during an iteration. As long as the number of participating parties in each iteration satisfies |Pt|≥α|Ph|, the final model can be computed.

To ensure consistency, one could assume a dispute phase between the assisting nodes where if a user is missing from a certain assisting node's list, the missing user participation message (signature) can be delivered to the assisting node to update their list. It is also assumed the same star network topology where the user sends everything through the aggregation server and the server distributes them to the assisting nodes.

Privacy Against Semi-Honest Adversary. Following [3, 7, 18], consider two scenarios. In the first one, the adversary only controls a subset of the users and assisting nodes, but not the server. The proof of such a setting is rather trivial since the joint view of any subset of the users and assisting nodes is fully independent of other entities in the system. The second scenario considers the adversary that controls the aggregation server in addition to a subset of users and assisting nodes. The security of the protocol is proven against such a semi-honest adversary in the following.

Theorem 2. The e-SeaFL protocol presented in FIGS. 3A and 3B (i.e. Algorithm 1) and FIGS. 4A and 4B (i.e. Algorithm 2), running with n parties {P₁, . . . , Pₙ}, k assisting nodes {A₁, . . . , Aₖ}, and an aggregation server S provides privacy against a semi-honest adversary Adv which controls S and 1−α fraction of users and k−1 assisting nodes with the offline rate (1−δ)≥α.

Proof. Following Definition 9, Theorem 2 is proven by the standard hybrid argument using the simulator, Sim. The proof relies on showing the indistinguishability between different hybrids.

The behavior of the simulator Sim is defined in each round of the Setup and Aggregation phase. In the following, the set of all parties is defined as [symbol] , honest parties as [symbol] ₕ and corrupt parties as [symbol] _{C}, i.e., [symbol] C= [symbol] / [symbol] ₕ. the same notation is applied to the set of assisting nodes [symbol] .

### Setup Phase:

(1) Each honest user Pᵢ and assisting node Aⱼ follows the protocol in Algorithm 1 (see FIGS. 3A and 3B).

(2) For each corrupt user Pᵢ∈ [symbol] _{C} and honest assisting node Aⱼ∈ [symbol] ₕ, Aⱼ computes and stores

$${x}_{{Pi}^{′}}^{Aj} ← \sum \cdot Agree ( {sk}_{\sum }^{Aj} , {pk}_{\sum }^{{Pi}^{′}} ) .$$

(3) For each honest user Pᵢ∈ [symbol] _{H} and corrupt assisting node Aⱼ∈ [symbol] _{C}, Pᵢ computes and stores

$${x}_{Aj}^{Pi} ← \sum \cdot Agree ( {sk}_{\sum }^{Pi} , {pk}_{\sum }^{{Aj}^{′}} ) .$$

(4) For each honest pair of user Pᵢ and honest assisting node Aⱼ, Sim picks xᵣ

$${←}^{\$} {𝒦}_{\sum }$$

and sets

$${x}_{Aj}^{Pi} = {x}_{Pi}^{Aj} = {x}_{r} .$$

(1) In each iteration t of the protocol, each honest user picks a random

$${{y}^{′}}_{t}^{Pi}$$

and sends t to the assisting nodes and

$$( {{y}^{′}}_{t}^{Pi} , t )$$

to the server.

(2) The aggregation server S first adds the user Pᵢ to the list [symbol] _{s,t} and then calls the α-summation ideal functionality [symbol] _{x,a} ( [symbol] _{S,t}/ [symbol] _{c}) (where [symbol] _{c} is the set of corrupt users) to get wₜ.

(3) Next, the simulator samples

$${{w}^{′}}_{t}^{Pi} {←}^{\$} {ℳ}^{d}$$

for all Pᵢ∈ [symbol] _{s,t}\ [symbol] _{C} such that wₜ=

$${\sum }_{i ∈ {𝒫}_{C}} {{w}^{′}}_{t}^{Pi}$$

and computes

$${{a}^{′}}_{t}^{Pi} = {{y}^{′}}_{t}^{Pi} - {{w}^{′}}_{t}^{Pi} ,$$

by utilizing random oracle, Sim sets

$${\{ {{a}^{′}}_{Aj , t}^{Pi} \}}_{Aj ∈ {𝒜}_{H}} = {\{ RO ( {x}_{Aj}^{Pi} , t \}}_{Aj ∈ {𝒜}_{H}}$$

such that a

$${{a}^{′}}_{t}^{Pi} = {\sum }_{Aj ∈ {𝒜}_{H}} \{ {{a}^{′}}_{Aj , t}^{Pi} \} ,$$

and for each Aⱼ∈ [symbol] _{H}, it computes

$$\{ {{a}^{′}}_{Pi , t}^{Aj} = {\sum }_{Pi ∈ 𝒫} \{ {{a}^{′}}_{Aj , t}^{Pi} \} .$$

The hybrids are presented below. The hybrids represent different views of the system as seen by corrupted entities (e.g., aggregation server, assisting nodes, and/or users), and the proof is based on the assumption that these views are computationally indistinguishable from each other. The simulator Sim is used to construct these hybrids, and the adversary Adv controls the corrupted entities.

Hyb0. This random variable is distributed identical to REAL, i.e., the real execution of the protocol where Adv interacts with the honest entities.

Hyb1. In this hybrid, a simulator which has knowledge on all the secrets of the honest parties (in each iteration) is introduced. The distribution of this hybrid is identical to the previous one.

Hyb2. In this hybrid, the behavior of the simulated honest parties Pᵢ∈ [symbol] _{H} and assisting nodes Aⱼ∈ [symbol] _{H} are c lange by selecting a random shared secret key from the key space K° instead of instantiating the Σ.Agree(⋅) algorithm. The indistinguishability of this hybrid with the one before is guaranteed by the security of the instantiated key exchange protocol. For instance, with the Diffie-Hellman key exchange protocol, this is guaranteed by the 2ODH assumption [7].

Hyb3. In this hybrid, each honest user Pᵢ∈ [symbol] _{H} replaces

$${y}_{t}^{Pi}$$

it sends to the server with a random vector

$${y}_{t}^{′ Pi} .$$

As aforementioned, the method requires at least one of the assisting nodes in the protocol to be honest. Therefore, the indistinguishability of this hybrid is guaranteed since Adv does not have knowledge on the honest entity's secret and hence in REAL the masked update will have the same distribution as

$${y}_{t}^{′ Pi}$$

### in Simul.

Hyb4. In this hybrid the aggregated masking term outputted is replaced by the honest assisting nodes Aᵢ∈ [symbol] _{H} with

$${a}_{Pi , t}^{′ Aj}$$

(computed in Step 3 of the simulated Aggregation phase presented above) by calling the idea functionality [symbol] _{x,a} ( [symbol] _{S,t}/ [symbol] _{C}) and utilizing a random oracle. Note that the view of this hybrid is indistinguishability with the previous hybrid since Adv does not have any knowledge on the honest entities shared secret and the distribution of the aggregate masking term in Simul is identical to the one in REAL.

Hyb5. In this hybrid, Sim sends the output of the ideal functionality (as in Step 2 in the simulated Aggregation phase above) as the universal model update wₜ for iteration t. Note that the ideal functionality will not return L based on the condition on the fraction of the honest users. Hence, this hybrid is indistinguishability from the previous one given the local updates are not known by Adv in REAL.

In the above, it was shown that the view of all the corrupted parties controlled by Adv is computationally indistinguishable.

Privacy Against Malicious Adversaries. Two possible scenarios are considered for the malicious setting. The first scenario that the malicious adversary Adv does not have control over the server can be easily proven using the same rationale as in Security Analysis section. In the following, an Adv that controls S along with a subset of the users and assisting nodes is considered.

Theorem 3. The e-SeaFL protocol presented in in FIGS. 3A and 3B (i.e. Algorithm 1) and FIGS. 4A and 4B (i.e. Algorithm 2), running with n parties {P₁, . . . , Pₙ}, k assisting nodes {A₁, . . . , Aₖ}, and an aggregation server S provides privacy against a malicious adversary Adv which controls S and 1−α fraction of users and k−1 assisting nodes with the offline rate (1−δ)≥α.

Proof. Following Definition 9 and similar to the proof of Theorem 2, the above theorem is proven by the standard hybrid argument using the simulator Sim. In the following, the set of all parties is defined as [symbol] , honest parties as [symbol] _{H} and corrupt parties as [symbol] _{c}, i.e., [symbol] _{c}= [symbol] / [symbol] _{H}. The same notation is applied to the set of assisting nodes [symbol] . Sim behaves as follows in each round of the Setup and Aggregation phase.

### Setup Phase:

Each honest user Pᵢ and assisting node Aⱼ follows the protocol in Algorithm 1 (see FIGS. 3A and 3B).

(2) For each corrupt user Pᵢ∈P_{c} and honest assisting node Aⱼ∈ [symbol] ₕ, Aⱼ computes and stores

$${x}_{{Pi}^{′}}^{Aj} ← Σ . Agree ( {sk}_{Σ}^{Aj} , {pk}_{Σ}^{{Pi}^{′}} ) .$$

(3) For each honest user Pᵢ∈ [symbol] _{H} and corrupt assisting node Aⱼ∈ [symbol] _{c}, Pᵢ computes and stores

$${x}_{Aj}^{Pi} ← Σ . Agree ( {sk}_{Σ}^{Pi} , {pk}_{Σ}^{Aj} ) .$$

(4) For each honest pair of user Pᵢ and honest assisting node Aⱼ, Sim picks xᵣ

$${←}^{\$} {𝒦}_{Σ} and sets {x}_{Aj}^{Pi} = {x}_{Pi}^{Aj} = {x}_{r} .$$

### Aggregation Phase:

(1) In each iteration t of the protocol, each honest user picks a random

$${y}_{t}^{′ Pi} .$$

It then computes two signatures

$${σ}_{S}^{Pi} ← Π . Sign ( {sk}_{Π}^{Pi} , m ) and {σ}_{Aj}^{Pi} ← Π . Sign ( {sk}_{Π}^{Pi} , {m}^{′} )$$

and sends

$$( m , {σ}_{S}^{Pi} ) and ( {m}^{′} , {σ}_{Aj}^{Pi} )$$

to the aggregation server and the assisting node Aⱼ (for j∈[l, . . . , k]) respectively.

(2) The aggregation server S first adds the user Pᵢ to the list [symbol] _{s,t} and then calls the α-summation ideal functionality [symbol] _{x,a}( [symbol] _{s,t}/ [symbol] _{c}) (where [symbol] _{c} is the set of corrupt users) to get wₜ.

(3) Next, the simulator samples

$${w}_{t}^{′ Pi} {←}^{\$} {ℳ}^{d}$$

for all Pᵢ∈ [symbol] _{s,t}/ [symbol] _{c} such that

$${w}_{t} = {\sum }_{i ∈ {𝒫}_{C}} {w}_{t}^{′ Pi}$$

and computes

$${a}_{t}^{′ Pi} = {y}_{t}^{′ Pi} - {w}_{t}^{′ Pi} ,$$

by utilizing random oracle, Sim sets

$${\{ {a}_{Aj , t}^{′ Pi} \}}_{Aj ∈ {𝒜}_{H}} = {\{ RO ( {x}_{Aj}^{Pi} , t \}}_{Aj ∈ {𝒜}_{H}} such that {a}_{t}^{′ Pi} = {\sum }_{Aj ∈ {𝒜}_{H}} \{ {a}_{Aj , t}^{′ Pi} \} ,$$

and for each Aⱼ∈ [symbol] _{H}, it computes

$$\{ {a}_{Pi , t}^{′ Aj} = {\sum }_{Pi ∈ 𝒫} \{ {a}_{Aj , t}^{′ Pi} \} .$$

The hybrids are presented below and follow the same approach for transitioning between hybrids as in the proof of Theorem 2.

Hyb0. This random variable is distributed identical to REAL, i.e., the real execution of the protocol where Adv interacts with the honest entities.

Hyb1. In this hybrid, a simulator which has knowledge on all the secrets of the honest parties (in each iteration) is introduced. The distribution of this hybrid is identical to the previous one.

Hyb2. In this hybrid, the behavior of the simulated honest parties Pᵢ∈P_{H} and assisting nodes Aⱼ∈ [symbol] _{H} are changed by selecting a random shared secret key from the key space K° instead of instantiating the Σ.Agree(⋅) algorithm. The indistinguishability of this hybrid with the one before is guaranteed by the security of the instantiated key exchange protocol. For instance, with the Diffie-Hellman key exchange protocol, this is guaranteed by the 2ODH assumption [7].

Hyb3. In this hybrid, each honest user Pᵢ∈ [symbol] _{H} samples a random vector

$${y}_{t}^{′ Pi}$$

for the update domain. It also computes a signature

$${σ}_{S}^{Pi} ← Π . Sign ( {sk}_{Π}^{Pi} , < {y}_{t}^{′ Pi} , t > )$$

and sends

$$( {y}_{t}^{′Pi} , {σ}_{S}^{Pi} )$$

to the server. Firstly, the indistinguishability of

$${σ}_{S}^{Pi}$$

is guaranteed by the underlying signature scheme. Secondly, as aforementioned, it is required that at least one of the assisting nodes in the protocol is honest. Therefore, the indistinguishability of this hybrid is guaranteed since Adv does not have knowledge on the honest entity's secret and hence in REAL the masked update will have the same distribution as

$${y}_{t}^{′Pi}$$

### in Simul.

Hyb4. In this hybrid the idea functionality is defined as [symbol] _{x,a}( [symbol] _{S,t}/ [symbol] _{C}) and utilize random oracles to replace the aggregated masking term outputted by the honest assisting nodes Aᵢ∈ [symbol] _{H} with

$${a}_{Pi , t}^{′ Aj}$$

(computed in Step 3 of the simulated Aggregation phase presented above). The output of this hybrid is

$$( {a}_{Pi , t}^{′ Aj} , {σ}_{S}^{Aj} ) where {σ}_{S}^{Aj} ← Sign ( {sk}_{Π}^{Pi} , {m}^{″} ) .$$

The indistinguishability of

$${σ}_{S}^{Aj}$$

is provided via the security of the underlying signature scheme. Hence, the view of this hybrid is indistinguishability with the previous hybrid since Adv does not have any knowledge on the honest entities shared secret and the distribution of the aggregate masking term in Simul is identical to the one in REAL.

Hyb5. In this hybrid, Sim sends the output of the ideal functionality (as in Step 2 in the simulated Aggregation phase above) as the universal model update wₜ for iteration t. Note that the ideal functionality will not return L based on the condition on the fraction of the honest users. Hence, this hybrid is indistinguishability from the previous one given the local updates are not known by Adv in REAL.

In the above, it is shown that the view of all the corrupted parties controlled by Adv is computationally indistinguishable.

Lemma 1. The protocol provided in FIGS. 3A and 3B (i.e. Algorithm 1) and FIGS. 4A and 4B (i.e. Algorithm 2) with APVC offers local model's privacy and aggregation integrity against semi-honest/malicious adversary Adv.

Proof. To prove this lemma, first the local model's privacy is proven in the presence of APVC, following the proof of Theorems 2 and 3 and how it affects the certain hybrids in the proofs. Then, the aggregation integrity is proven. As highlighted in the protocol description, in its plain form, it is required that the initiating assisting node Aⱼ to be honest. This proof applies to the other extensions discussed herein.

In the Setup phase and Hyb2 of the proofs Aⱼ samples random ρ and

$${c}_{Aj}^{Pi} .$$

Note that the indistinguishability of this hybrid would also rely on the security of the underlying vector commitment scheme APVC and the authenticated symmetric encryption scheme AE. In Hyb3, the user will also outputs cmₜ^{Pi}. Note that the indistinguishability of this hybrid relies on the hiding property of the underlying vector commitment scheme APVC.

In Hyb5, Sim sets x←g^{w}^{ₜ}^{·ρ} and sends x along with the final model wₜ. Therefore, the view of all the corrupted parties controlled by Adv is computationally indistinguishable.

Next, is a proof of model integrity. The unforgeability property of APVC permits the user to verify whether the linear combination of local weight models (which is the aggregation) has been computed correctly. Let

$${w}_{t}^{′} = {w}_{t} + ∈$$

be the tampered aggregated model, where ε is the error vector introduced by the malicious server and

$${w}_{t} = {\sum }_{i = 1}^{n} {w}^{Pi}$$

is the aggregated model that is supposed to be computed honestly in the iteration t. For the user to accept

$${w}_{t}^{′} ,$$

the server needs to somehow generate a valid

$${g}^{{w}_{t} \cdot ρ} = {g}^{( {\sum }_{i = 1}^{n} {w}^{Pi} + ∈ ) \cdot ρ}$$

from

$${\{ {g}^{{w}^{Pi \cdot ρ}} {h}^{{r}^{Pi}} \}}_{i ∈ [ n ]} .$$

Given that ρ and all {r^{Pi}}_{i∈[n]} are secret to the server, this happens with only a negligible probability due to the unforgeability property (by Definition 6) of APVC, which only permits the server to perform the predefined linear combination of gWPL, but nothing else.

### Experimental Evaluation

Implementation and configurations. The protocol was implemented in Python with 1500 lines of code. The coincurve library [25] was used to implement public key primitives based on the elliptic curve (EC), including ECDSA signature and EC Diffie-Hellman (ECDH) key exchange protocols. The Python cryptographic libraries (i.e., hmac and hashlib) were used to implement hash functions for the masking terms. The standard Python socket was also used to implement communication between all the parties.

Parameter choice and counterpart comparison. As alluded to, there is a large body of research on privacy-preserving aggregation protocol for federated learning. However, a recent protocol, MicroFedML [18], allows for the reuse of the masking terms in each iteration and hence, has achieved significant communication and computation efficiency. Therefore, MicroFedML is considered as the counterpart to evaluate the performance of e-SeaFL.

The parameters were selected for the protocol and its counterpart to achieve 128-bit security as follows.

e-SeaFL: The secp256k1 curve was used with 256-bit group order for ECDSA and ECDH protocols. The SHA-256 was used for mask generation and set the number of assisting nodes k=3. The scheme was evaluated in both Semi-Honest (SH) and Malicious (MS) settings.

MicroFedML [18]: The e-SeaFL was compared with the two MicroFedML instantiations [18], namely, MicroFedML1 and MicroFedML2, in the semi-honest setting. In MicroFedML1, all users communicate with each other via the aggregation server (star topology). To improve efficiency, following the idea in [3], the users are grouped in smaller sets In MicroFedML2. The group size of 50 in MicroFedML2 was selected. The originally suggested parameters and cryptographic instantiations [18] were used, including 2048-bit prime, XSalsa20 for authenticated encryption, Diffie-Hellman key exchange, and SHA-256 hash function. Due to its underlying building blocks, MicroFedML can only handle weights up to 20 bits.

Evaluation setting and metrics. The protocol and its counterpart were evaluated on a local Macbook Pro 2021 with a 3.2 GHz M1 Pro CPU and 16 GB RAM. A range of 200 to 1000 users, three assisting nodes, and one aggregation server were considered. The computation time and the outbound bandwidth cost of the server, the users, and the assisting nodes (in the protocol) were measured in both the Setup and Aggregation phases.

To demonstrate the performance of e-SeaFL with high-dimensional gradient vectors, the performance was reported when the weight vector w consists of 100,000 gradients. In fact, compared to the existing works (e.g., [18]), the protocol offers a much higher efficiency for weight vectors with high dimensions since it does not require any expensive operations (e.g., solving for the discrete logarithm) to compute the final model from local updates. In MicroFedML, the authors only reported performance for single gradients. The results were projected for 100,000 gradient vectors. For a fair comparison, the results for a single value gradient were also reported. All the experiments were run ten times and reported the average.

### Results

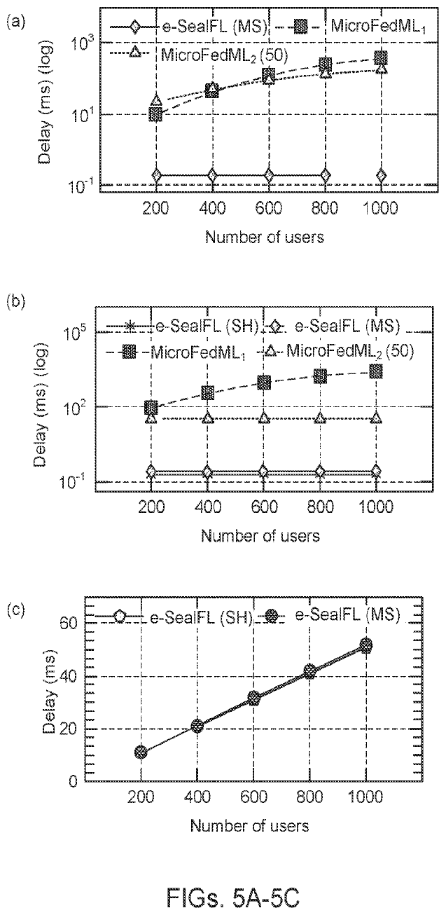

Setup phase computation. FIGS. 5A-5C depict the computation cost of the protocol in the Setup phase compared with the one in MicroFedML. As depicted in FIGS. 5A-5C, e-SeaFL outperforms MicroFedML for both server and user computation in the semi-honest setting. Specifically, in the semi-honest setting, the server does not incur any computation, while in the malicious setting, the server takes 0.19 ms to setup (generate an ECDSA key pair), compared to 375.75 and 177.77 ms for MicroFedML1 and MicroFedML2 (FIG. 2A), respectively. In MicroFedML protocols, given their design, the server is responsible for communicate all the keys among the users. Thus, the malicious scheme is 53×-1977× (for the defined number of users range) faster than MicroFedML1 and 117×-936× faster than MicroFedML2.

As shown in FIG. 5B, the user computation in the semi-honest (resp. malicious) e-SeaFL is 470×-13284× (resp. 352×-9962×) faster than MicroFedML1 and 173× (resp. 129×) faster than MicroFedML2, where each user only takes 0.18 ms (resp. 0.25 ms) to setup, while MicroFedML1 and MicroFedML2 take 2509.34 ms and 32.71 ms, respectively, for 1000 users. Similar to the server cost, e-SeaFL incurs a constant user time regardless of the number of users. Each user only needs to compute a single ECDH key pair (plus a single ECDSA key pair in the malicious setting), and compute the shared secret with each assisting node. In MicroFedML, however, after creating the DH keys and computing the shared secret key with all other users, the user needs to sample masking term, secret share it to n shares, and encrypt each of the n shares with the shared secret key of all the users in the system.

Unlike MicroFedML, e-SeaFL requires assisting nodes to aid secure aggregation. However, the computation costs associated with assisting node in e-SeaFL is highly efficient, where it only takes 11.01 ms and 50.88 ms in semi-honest setting (and 11.08 ms-51.78 ms in the malicious setting) to setup key materials for 200 to 1000 users (FIG. 5C). Each node computes an ECDH key pair (plus an ECDSA key pair in the malicious setting), and a shared secret seed for each user, and thus the overhead grows linearly w.r.t the number of users.

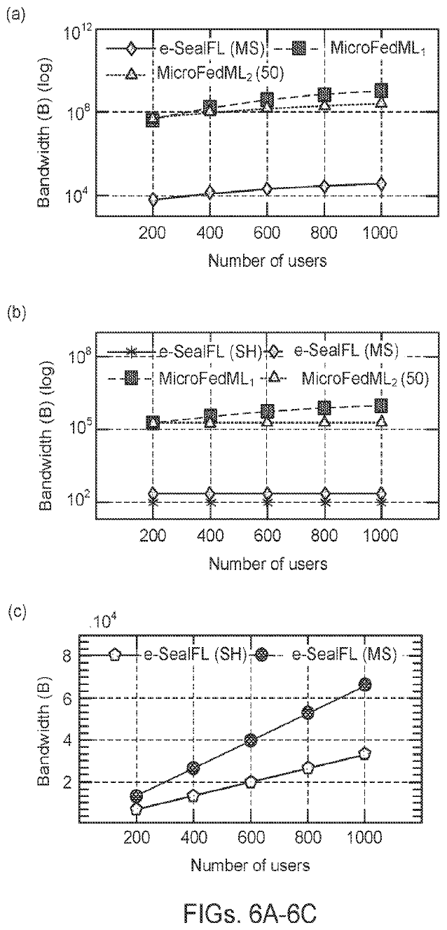

Outbound bandwidth. The outbound bandwidth cost of all entities in e SeaFL is presented in FIGS. 6A-6C. In the malicious setting, for 1000 users (FIG. 6A), the server transmits ~4-5 orders of magnitude less than MicroFedML1 and ~3-4 orders of magnitude less than MicroFedML2 (i.e., 33000 B vs. 1008 MB in MicroFedML1 and 240 MB in MicroFedML2). The server bandwidth in the malicious e-SeaFL protocol grows linearly as the number of users increases because the server transmits its ECDSA public key to 200 to 1000 users. Meanwhile, the semi-honest protocol does not require the server to transmit anything in the Setup phase. In MicroFedML however, due to the design, all the communications such as the distribution of the DH keys and encrypted shares need to be communicated via the aggregation server, which incurs a significant communication overhead.

As shown in FIG. 6B, user bandwidth in the semi-honest (resp. malicious) e-SeaFL is 1877×-9369× (resp. 804×-4015×) less than MicroFedML, where each user only transmits a fixed message of size 99 B (resp. 231 B), while for MicroFedML1 and MicroFedML2 protocols it is approximately 905 KB and 183 KB, respectively. It is because each user only needs to transmit an ECDH public key (plus an ECDSA public key in the malicious setting) to a fixed number of assisting nodes. In MicroFedML, the users send (via the aggregation server) their DH public keys along with the encrypted masking shares to all other users in the system.

The bandwidth cost of assisting nodes in e-SeaFL is negligible, where each node only transmits to 200-1000 users a total of 6-32 KB for the semi honest protocol and 13-64 KB message for the malicious protocol (FIG. 6C). The overhead is due to the broadcast of an ECDH public key (and an ECDSA public key in the malicious setting) to all the users (and the aggregating server), and thus, its bandwidth cost grows linearly with respect to the number of users.

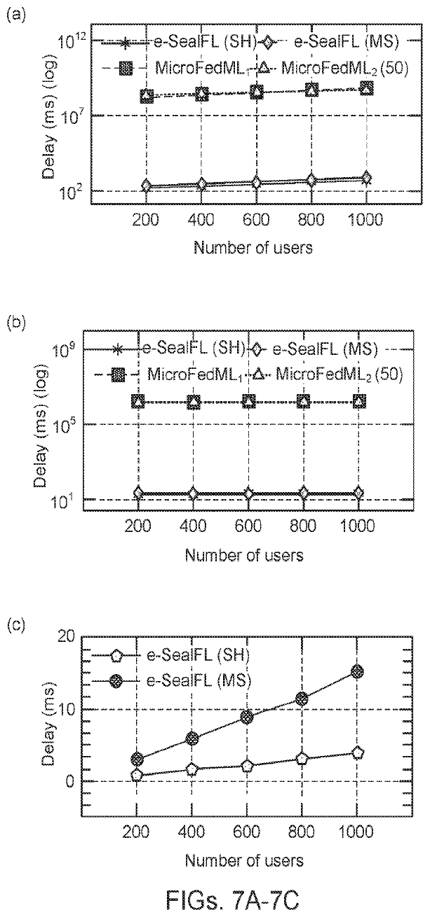

Aggregation phase. Computation. FIGS. 7A-7C show the computational cost in the aggregation phase for both e-SeaFL and MicroFedML. In the protocol, all entities incur a small computation overhead in the Aggregation phase. In particular, for a single gradient, the server computation time in the semi-honest (resp. malicious) protocol is 815×-1224× (resp. 139×-187×) faster than MicroFedML1 and 891×-1065× (resp. 117×-222×) faster than MicroFedML2. When the 100,000 gradients vector are considered, the server computation time in both of the semi-honest and malicious protocol is approximately six orders of magnitude faster than those in MicroFedML1 and MicroFedML2. When there are 200 users, the server computation time in semi-honest and malicious e-SeaFL is only 150.41 ms and 207.34 ms, respectively. The server computation time in both settings grows linearly as the number of users increases. In the semi-honest protocol, the majority of the aggregation server's cost is due to the linear summation of the weights and the aggregated masking terms provided by the assisting nodes. The added 82%-85% of extra overhead in the malicious setting is due to the signature verification on the local weights sent by the parties and the signatures on the aggregated masks sent by the assisting nodes.

For a single gradient, user computation in semi-honest (resp. malicious) e SeaFL is 300×-318× (resp. 120×-127×) faster than the one in MicroFedML1. As shown in FIG. 7B, for 100,000 gradients vector, the gap increases and the user computation in semi-honest and malicious e-SeaFL becomes approximately five orders of magnitude faster than the ones in MicroFedML1 and MicroFedML2. More precisely, for 1000 users, the user computation time in the semi-honest (resp. malicious) protocol is only 18.48 ms (resp. 20.21 ms). The user computation time of the protocol in both settings remains constant as the number of users grows. Each user computes the masked update by invoking the hash function (SHA-256) k times (plus two ECDSA signatures in the malicious setting). Therefore, the cost is linear to the (small) number of assisting nodes rather than the number of users. In MicroFedML, after computing the mask update via additive masking the user needs to compute the aggregation of the masking shares in the exponent.

The computation time of the assisting nodes increases with the number of users as shown in FIG. 7C; however, the overhead is small. Specifically, for 200-1000 users the assisting node's time is 0.73-3.90 ms in the semi honest setting and 3.03-15.22 ms in the malicious setting, due to computing the aggregated masks for all the users (28%-%40 of total delay), and the signature verification (in the malicious setting that contributes an extra 60%-72% overhead).

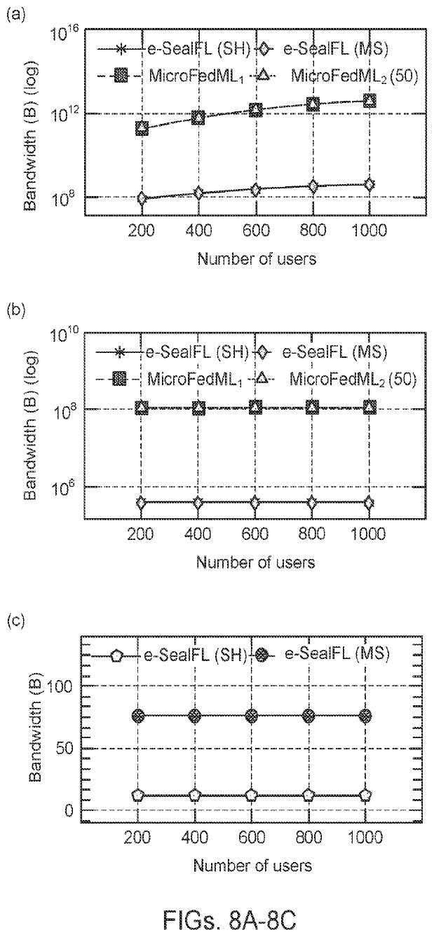

Outbound bandwidth. In FIGS. 8A-8C, the outbound bandwidth costs of the Aggregation phase was compared for all the entities in the protocol with the ones in MicroFedML. It was observed that the outbound bandwidth cost for the server and the user in the protocol was considerably lower than those in the MicroFedML protocols. As presented in FIG. 8A, the server in the semi-honest (resp. malicious) protocol incurs 2564×-10000× (resp. 2564×-10000×) less outbound bandwidth overhead compared to MicroFedML protocols. Specifically, for 1000 users, the protocol incurs 390625 KB (model size) in the semi-honest and 390625 KB plus an additional 64 B (for signature) in the malicious setting, compared with 3814697 MB in MicroFedML. In MicroFedML, the server needs to send the list of online users to all the users in the system. Note that the overhead of distributing the final model to all users is not captured in MicroFedML.

As shown in FIG. 8B, the user outbound bandwidth cost in the semi-honest (resp. malicious) protocol is 279× (resp. 278×) lower than the one in MicroFedML. Specifically, the user outbound bandwidth is 400016 B for the semi-honest and 400272 B for the malicious protocol, while it is 108996 KB in MicroFedML. In addition, the user outbound bandwidth in e-SeaFL depends on the number of assisting nodes (which is a small constant), and thus, it does not increase as the number of users increases during the aggregation phase. Specifically, the user transmits the masked model and the iteration number (along with signature in the malicious setting) to the aggregation server, and the iteration number (along with signature in the malicious setting) to the three assisting nodes. In MicrofedML, aside from sending the masked update, the user sends the aggregation of the shares for all online users to the server.

The outbound bandwidth cost of the assisting nodes in the protocol is small and does not depend on the number of users. Specifically, in the semi-honest setting, the node only sends a message of size 12 B consisting of the masking term (4 B), the iteration number (4 B) (for t≤128), and the length of the user list (4 B). For the malicious setting, a signature of size 64 B will also be transmitted.

Performance of Proof of Aggregation Integrity. The performance of the technique based on APVC was measured to achieve aggregation integrity against malicious server. In the setup phase, the assisting node samples a random secret of size 32 B and sends its authenticated ciphertext (56 B) to all the users, resulting in a total outbound bandwidth of 11200-56000 B for 200-1000 users. The encryption (or decryption at the user side) takes roughly 40-200 ms for 200-1000 users.

In the aggregation phase, each user computes the authenticated commitment with EC operations, which takes 52208 ms (mostly due to EC scalar multiplication) and incurs 64 B outbound bandwidth to send it to the server. The server performs aggregation over the authenticated commitments received from all the users, which takes a total of 4.02 ms-20.72 ms (mostly due to EC point additions) and incurs a total of outbound bandwidth of 12800-64000 B for 200-1000 users.

### DISCUSSION

Most existing works (listed in Table 1) require multiple rounds of communication, each of which often incurs a high user computation overhead. Some use homomorphic encryption, e.g., [10, 31], which, instead, often incurs very high computational overhead for high-dimensional vectors. These works (e.g., [18]) might not scale for large models (e.g., foundation models [6]) with billions of parameters [15], failing the first and second requirements, or scale with the number of users (e.g., [1]).

TABLE 1
Communication cost of a user for a training iteration

| | BIK | BBG | MicroFedML₁ | MicroFedML₂ | |
|---|---|---|---|---|---|
| Round | [7] | [3] | [18] | [18] | e-SeaFL |
| 1: | O(n) | O(1) | 1 | 1 | O(k) + 1 |
| 2: | O(n) | O(log n) | 1 + n bits | 1 + log n bits | |
| 3: | 1 | O(log n) | O(n) | O(log n) | |
| 4: | O(n) | 1 | | | |
| 5: | O(n) | O(log n) | | | |
| 6: | | O(log n) | | | |

Meanwhile, most existing protocols can only tolerate a small fraction of user dropouts since enough shares are needed to reconstruct the secrets of the dropout users. Lastly, most prior works assume the aggregation server always yields honest aggregations of the individual gradients, which may not be the case in practice. This assumption can have adverse consequences in certain applications (e.g., [26]) where the trained model can be later comprised by exploiting the maliciously aggregated final model [5, 8, 13].

An Efficient SEcure Aggregation for Federated Learning (e-SeaFL) is proposed that tackles all of the above challenges [7]. As Table 1 shows, e-SeaFL only requires one communication round during aggregation. e-SeaFL also significantly minimizes the computational overhead as compared to the state-of-the-art [18]. For instance, for gradients vectors with 100,000 weights from with 1,000 users (see FIGS. 7A-7C), e-SeaFL is around five orders of magnitudes faster in the aggregation phase for both users and the server. Given its efficiency, e-SeaFL can efficiently handle high-dimension gradient vectors required for training capable large/foundation models [6]. e-SeaFL also scales out to a large number of users and is highly tolerant to dropout users. Last but not least, e-SeaFL allows the aggregation server to generate a proof of honest aggregation in each iteration to ensure the integrity of the model. e-SeaFL is secure in both the semi-honest and malicious settings.

### REFERENCES

[1] Constance Beguier and Eric W Tramel. 2020. Safer: Sparse secure aggregation for federated learning. arXiv preprint arXiv:2007.14861 (2020).
[2] Rouzbeh Behnia and Attilla Altay Yavuz. 2021. Towards Practical Post-Quantum Signatures for Resource-Limited Internet of Things. In Annual Computer Secu-rity Applications Conference (Virtual Event, USA) (ACSAC '21). Association for Computing Machinery, New York, NY, USA, 119-130.
[3] James Henry Bell, Kallista A. Bonawitz, Adrià Gascón, Tancrede Lepoint, and Mar-iana Raykova. 2020. Secure Single-Server Aggregation with (Poly)Logarithmic Overhead. In Proceedings of the 2020 ACM SIGSAC Conference on Computer and Communications Security (Virtual Event, USA) (CCS '20). Association for Comput-ing Machinery, New York, NY, USA, 1253-1269. https://doi.org/10.1145/3372297. 3417885
[4] Mihir Bellare and Chanathip Namprempre. 2000. Authenticated encryption: Relations among notions and analysis of the generic composition paradigm. In Advances in Cryptology—ASIACRYPT 2000: 6th International Conference on the Theory and Application of Cryptology and Information Security Kyoto, Japan, Dec. 3-7, 2000 Proceedings 6. Springer, 531-545.
[5] Arjun Nitin Bhagoji, Supriyo Chakraborty, Prateek Mittal, and Seraphin Calo. 2018. Model poisoning attacks in federated learning. In Proc. Workshop Secur. Mach. Learn.(SecML) 32nd Conf. Neural Inf. Process. Syst.(NeurIPS). 1-23.
[6] Rishi Bommasani, Drew A Hudson, Ehsan Adeli, Russ Altman, Simran Arora, Sydney von Arx, Michael S Bernstein, Jeannette Bohg, Antoine Bosselut, Emma Brunskill, et al. 2021. On the opportunities and risks of foundation models. arXiv preprint arXiv:2108.07258 (2021).
[7] Keith Bonawitz, Vladimir Ivanov, Ben Kreuter, Antonio Marcedone, H Brendan McMahan, Sarvar Patel, Daniel Ramage, Aaron Segal, and Karn Seth. 2017. Prac-tical secure aggregation for privacy-preserving machine learning. In proceedings of the 2017 ACM SIGSAC Conference on Computer and Communications Security. 1175-1191.
[8] Xiaoyu Cao and Neil Zhenqiang Gong. 2022. MPAF: Model Poisoning Attacks to Federated Learning based on Fake Clients. In Proceedings of the IEEE/CVF Conference on Computer Vision and Pattern Recognition. 3396-3404.
[9] Melissa Chase and Sherman S. M. Chow. 2009. Improving privacy and security in multi-authority attribute-based encryption. In Proceedings of the 2009 ACM Conference on Computer and Communications Security, C C S 2009, Chicago, Illinois, USA, Nov. 9-13, 2009. ACM, 121-130.
[10] Vishnu Asutosh Dasu, Sumanta Sarkar, and Kalikinkar Mandal. 2022. PROV-FL: Privacy-preserving Round Optimal Verifiable Federated Learning. In Proceedings of the 15th ACM Workshop on Artificial Intelligence and Security. 33-44.
[11] Bernardo David, Bernardo Magri, Christian Matt, Jesper Buus Nielsen, and Daniel Tschudi. 2022. GearBox: Optimal-size Shard Committees by Leveraging the Safety-Liveness Dichotomy. In Proceedings of the 2022 ACM SIGSAC Conference on Computer and Communications Security. 683-696.
[12] David Evans, Vladimir Kolesnikov, Mike Rosulek, et al. 2018. A pragmatic intro-duction to secure multi-party computation. Foundations and Trends® in Privacy and Security 2, 2-3 (2018), 70-246.
[13] Minghong Fang, Xiaoyu Cao, Jinyuan Jia, and Neil Gong. 2020. Local model poisoning attacks to {Byzantine-Robust} federated learning. In 29th USENIX Security Symposium (USENIX Security 20). 1605-1622.
[14] Hossein Fereidooni, Samuel Marchal, Markus Miettinen, Azalia Mirhoseini, Helen Möllering, Thien Due Nguyen, Phillip Rieger, Ahmad-Reza Sadeghi, Thomas Schneider, Hossein Yalame, et al. 2021. SAFELearn: secure aggregation for private federated learning. In 2021 IEEE Security and Privacy Workshops (SPW). IEEE, 56-62.
[15] Luciano Floridi and Massimo Chiriatti. 2020. GPT-3: Its nature, scope, limits, and consequences. Minds and Machines 30, 4 (2020), 681-694.
[16] Joshua Goodman, Gina Venolia, Keith Steury, and Chauncey Parker. 2002. Language modeling for soft keyboards. In Proceedings of the 7th international conference on Intelligent user interfaces. 194-195.
[17] Xiaojie Guo, Zheli Liu, Jin Li, Jiqiang Gao, Boyu Hou, Changyu Dong, and Thar Baker. 2020. VeriFL: Communication-efficient and fast verifiable aggregation for federated learning. IEEE Transactions on Information Forensics and Security 16 (2020), 1736-1751.
[18] Yue Guo, Antigoni Polychroniadou, Elaine Shi, David Byrd, and Tucker Balch. 2022. MicroFedML: Privacy Preserving Federated Learning for Small Weights. Cryptology ePrint Archive (2022).
[19] Briland Hitaj, Giuseppe Ateniese, and Fernando Perez-Cruz. 2017. Deep models under the GAN: information leakage from collaborative deep learning. In Pro-ceedings of the 2017 ACM SIGSAC conference on computer and communications security. 603-618.
[20] Yutao Huang, Xiaoqiang Ma, Xiaoyi Fan, Jiangchuan Liu, and Wei Gong. 2017. When deep learning meets edge computing. In 2017 IEEE 25th international conference on network protocols (ICNP). IEEE, 1-2.
[21] Tayyebeh Jahani-Nezhad, Mohammad Ali Maddah-Ali, Songze Li, and Giuseppe Caire. 2022. Swiftagg: Communication-efficient and dropout-resistant secure aggregation for federated learning with worst-case security guarantees. arXiv preprint arXiv:2202.04169 (2022).
[22] Jakub Konečn'y, H Brendan McMahan, Daniel Ramage, and Peter Richtárik. 2016. Federated optimization: Distributed machine learning for on-device intelligence. arXiv preprint arXiv:1610.02527 (2016).
[23] Jakub Konečn'y, H Brendan McMahan, Felix X Yu, Peter Richtárik, Ananda Theertha Suresh, and Dave Bacon. 2016. Federated learning: Strategies for improving communication efficiency. arXiv preprint arXiv:1610.05492 (2016).
[24] Tung Le, Pengzhi Huang, Attila A Yavuz, Elaine Shi, and Thang Hoang. 2023. Efficient Dynamic Proof of Retrievability for Cold Storage. In The Network and Distributed System Security Symposium (NDSS) 2023.
[25] Ofek Lev. [n. d.]. Cross-platform Python bindings for libsecp256k1. https://github. com/ofek/coincurve.
[26] Sadegh M Milajerdi, Birhanu Eshete, Rigel Gjomemo, and VN Venkatakrishnan. 2019. Poirot: Aligning attack behavior with kernel audit records for cyber threat hunting. In Proceedings of the 2019 ACM SIGSAC conference on computer and communications security. 1795-1812.
[27] Moni Naor, Benny Pinkas, and Omer Reingold. 1999. Distributed Pseudo-random Functions and KDCs. In Advances in Cryptology—EUROCRYPT '99, International Conference on the Theory and Application of Cryptographic Techniques, Prague, Czech Republic, May 2-6, 1999, Proceeding. Springer, 327-346.
[28] Mayank Rathee, Conghao Shen, Sameer Wagh, and Raluca Ada Popa. 2022. ELSA: Secure Aggregation for Federated Learning with Malicious Actors. Cryptology ePrint Archive (2022).
[29] Adi Shamir. 1979. How to Share a Secret. Commun. ACM 22, 11 (nov 1979), 612-613. https://doi.org/10.1145/359168.359176
[30] Shiqiang Wang, Tiffany Tuor, Theodoros Salonidis, Kin K Leung, Christian Makaya, Ting He, and Kevin Chan. 2018. When edge meets learning: Adaptive control for resource-constrained distributed machine learning. In IEEE INFOCOM 2018-IEEE conference on computer communications. IEEE, 63-71.
[31] Chengliang Zhang, Suyi Li, Junzhe Xia, Wei Wang, Feng Yan, and Yang Liu. 2020.{BatchCrypt}: Efficient homomorphic encryption for {Cross-Silo} federated learning. In 2020 USENIX annual technical conference (USENIX ATC 20). 493-506.

1. A method for securely aggregating federated learning updates for a machine learning model, the method comprising:
executing a set-up routine, wherein the set-up routine comprises:
generating a plurality key pairs, wherein each user has a unique key pair and each of a plurality of assisting nodes has a unique key pair
$$( p {k}_{Σ}^{Aj} , {sk}_{Σ}^{Aj} ) ;$$
sharing a public key of the unique key pair of each user with each of the plurality of assisting nodes and a central server;
generating a plurality of shared secrets
$$( {x}_{Aj}^{Pi} ) ,$$
shared between each user and each of the plurality of assisting nodes;
iteratively executing an aggregation routine:
generating, at each user, a masked local update
$$( {y}_{t}^{Pi} )$$
comprising a related shared secret
$$( {x}_{Aj}^{Pi} ) ;$$
generating, at each of the plurality of assisting nodes, an unmasking term
$$( {a}_{t}^{Aj} )$$
related to the shared secret
$$( {x}_{Aj}^{Pi} ) ;$$
iteratively (t) updating the machine learning model at the central server by aggregating masked local model updates from each user
$$( {y}_{t}^{Pi} )$$
and unmasking terms
$$( {a}_{t}^{Aj} ) ;$$
and
sending the updated machine learning model to each user (wₜ).

2. The method of claim 1, further comprising:
at each iteration (t):
receiving, at each of the plurality of assisting nodes, a participation message (m′) from each user;
adding each user that sent a participation message (m′) to an assisting node user list (L_{j,t});
receiving, at the central server, a participation message (m) with the masked local update from each user;
adding each user that sent a participation message (m′) to a central server user list (L_{S,t});
comparing the assisting node user list of each assisting node to the central server user list, and
wherein in response to the comparison, aborting the iterative update when one or more assisting node user lists is not identical to the central server user list.

3. The method of claim 2, further comprising:
generating a signature key pair for each user
$$( {pk}_{Π}^{Pi} , {sk}_{Π}^{Pi} )$$
and each of the plurality of assisting nodes
$$( {pk}_{Π}^{Aj} , {sk}_{Π}^{Aj} ) ;$$
receiving, at each of the plurality of assisting node, a public signature key of each user
$$( p {k}_{Π}^{Pi} )$$
and receiving, at each user, the signature key of each of the plurality of assisting nodes
$$( p {k}_{Π}^{Aj} ) ;$$
receiving, at the central server, a public signature key for each user and each of the plurality of assisting nodes;
generating, at the central server, a signature key pair
$$( p {k}_{Π}^{S} , {sk}_{Π}^{S} ) ;$$
sending, from the central server, a public signature key to each of the users; and
verifying the public signature key of each user at the assisting nodes and central server; and
wherein when the public signature key of a user is verified, the user is added to the assisting node user list and to the central server user list.

4. The method of claim 2, further comprising:
generating, at each of the plurality of assisting nodes, an authentication factor (ρ);
generating as a function of the authentication factor (ρ) and shared secret
$$( {x}_{Aj}^{Pi} ) ,$$
at each of the plurality of assisting nodes, an encoding vector
$$( {c}_{Aj}^{Pi} ) ;$$
sending, from each of the plurality of assisting nodes, the encoding vector
$$( {c}_{Aj}^{Pi} )$$
to each user;
generating, at each user, the authentication factor (ρ) as a function of the encoding vector
$$( {c}_{Aj}^{Pi} )$$
and shared secret
$$( {x}_{Aj}^{Pi} ) ;$$
generating, at each user, a commitment vector
$$( {cm}_{t}^{Pi} )$$
as a function of the authentication factor (ρ);
sending, from each user to the central server, the commitment vector
$$( {cm}_{t}^{Pi} )$$
together with the masked local update
$$( {y}_{t}^{Pi} ) ;$$
generating, at the central server, an integrity factor (xₜ) as a function of the commitment vector
$$( {cm}_{t}^{Pi} ) ,$$
and the unmasking terms of each of the plurality of assisting nodes
$$( {a}_{t}^{Aj} ) ;$$
sending the updated machine learning model and integrity factor (xₜ) from the central server to each user; and
validating, as a function of the updated machine learning model, the authentication factor, and integrity factor;
wherein when the updated machine learning model is determined to be valid, accepting, at the user, the updated machine learning model.

5. The method of claim 1, wherein the set-up routine further comprises:
sharing a security parameter (κ), a number of assisting nodes (k), and a key exchange protocol (Σ) are shared parameters between each user, the plurality of assisting nodes, and the central server.

6. The method of claim 1, wherein the assisting nodes comprise a plurality of users or a plurality of servers on a shared network.

7. The method of claim 1, wherein the set-up routine is executed offline.

8. The method of claim 1, wherein communications are conducted on an authenticated channel.

9. The method of claim 1, wherein at least one assisting node is honest (i.e. not corrupt).

10. The method of claim 2, further comprising:
comparing a number of users in the assisting node user list to an allowable fraction of total number of users, wherein the allowable fraction is a tolerance factor for user dropout;
wherein when fewer users are in the assisting node list than the allowable fraction of total number of user, the unmasking term is not generated and the process aborts.

11. A system for securely aggregating federated learning updates for a machine learning model, comprising:
a distributed computing network, wherein the distributed computing network comprises:
a plurality of users ({P1, . . . , Pn}) comprising at least one processor and data storage;
a plurality of assisting nodes ({A1, . . . , Ak}) comprising at least one processor and data storage;
a central server (S) comprising at least one processor,
wherein the distributed computing network is configured to:
execute a set-up routine, wherein the set-up routine comprises:
generating a plurality key pairs, wherein each user has a unique key pair
$$( {pk}_{\sum }^{Pi} , {sk}_{\sum }^{Pi} )$$
and each of a plurality of assisting nodes has a unique key pair
$$( {pk}_{\sum }^{Aj} , {sk}_{\sum }^{Aj} ) ;$$
sharing a public key of the unique key pair of each user with each of the plurality of assisting nodes and a central server;
generating a plurality of shared secrets
$$( {x}_{Aj}^{Pi} ) ,$$
shared between each user and each of the plurality of assisting nodes;
iteratively execute an aggregation routine, wherein the aggregation routine comprises:
generating, at each user, a masked local update
$$( {y}_{t}^{Pi} )$$
comprising a related shared secret
$$( {x}_{Aj}^{Pi} ) ;$$
generating, at each of the plurality of assisting nodes, an unmasking term
$$( {a}_{t}^{Aj} )$$
related to the shared secret
$$( {x}_{Aj}^{Pi} ) ;$$
iteratively (t) updating the machine learning model at the central server by aggregating masked local model updates from each user
$$( {y}_{t}^{Pi} )$$
and unmasking terms
$$( {a}_{t}^{Aj} ) ;$$
and
sending the updated machine learning model to each user (wₜ).

12. The system of claim 11, wherein the distributed computing system is further configured to:
at each iteration (t):
receive, at each of the plurality of assisting nodes, a participation message from each user;
add each user that sent a participation message to an assisting node user list;
receive, at the central server, a participation message with the masked local update from each user;
add each user that sent a participation message to a central server user list; and
compare the assisting node user list of each assisting node to the central server user list;
wherein in response to the comparison, abort the iterative update when one or more assisting node user lists is not identical to the central server user list.

13. The system of claim 12, wherein the distributed computing system is further configured to:
generate a signature key pair for each user and each of the plurality of assisting nodes;
receive, at each of the plurality of assisting node, a public signature key of each user and receiving, at each user, the signature key of each of the plurality of assisting nodes;
receive, at the central server, the public signature key for each user and each of the plurality of assisting nodes;
generate, at the central server, a signature key pair;
send, from the central server, a public signature key to each of the users; and
verify the public signature key of each user at the assisting nodes and central server;
wherein when the public signature key of a user is verified, the user is added to the assisting node user list and to the central server user list.

14. The system of claim 11, wherein the distributed computing system is further configured to:
generate, at each of the plurality of assisting nodes, an authentication factor (ρ);
generate as a function of the authentication factor (ρ) and shared secret, at each of the plurality of assisting nodes, an encoding vector;
send, from each of the plurality of assisting nodes, the encoding vector to each user;
generate, at each user, the authentication factor (ρ) as a function of the encoding vector and shared secret;
generate, at each user, a commitment vector as a function of the authentication factor (ρ);
send, from each user to the central server, the commitment vector together with the masked local update;
generate, at the central server, an integrity factor as a function of the commitment vector, and the unmasking terms of each of the plurality of assisting nodes;
send the updated machine learning model and integrity factor from the central server to each user; and
validate, as a function of the updated machine learning model, the authentication factor, and integrity factor;
wherein when the updated machine learning model is determined to be valid, accepting, at the user, the updated machine learning model.

15. The system of claim 11, wherein the set-up routine further comprises:
sharing a security parameter (κ), a number of assisting nodes (k), and a key exchange protocol (Σ) are shared parameters between each user, the plurality of assisting nodes, and the central server.

16. The system of claim 11, wherein the plurality of assisting nodes comprise a plurality of users or a plurality of servers on a shared network.

17. The system of claim 11, wherein the set-up routine is executed offline.

18. The system of claim 11, wherein communications are conducted on an authenticated channel.

19. The system of claim 11, wherein at least one assisting node is honest (i.e. not corrupt).

20. The system of claim 12, wherein the distributed computing system is further configured to:
compare a number of users in the assisting node user list to an allowable fraction of total number of users, wherein the allowable fraction is a tolerance factor for user dropout;
wherein when fewer users are in the assisting node list than the allowable fraction of total number of user, the unmasking term is not generated and the process aborts.
